(19) United States
(12) Patent Application Publication
(10) Pub. No.: US 2011/0212359 A1
(43) Pub. Date: Sep. 1, 2011

(54) ELECTROCHEMICAL CELLS WITH IONIC LIQUID ELECTROLYTE

(75) Inventors: Hongli Dai, Los Altos, CA (US); Michael Erickson, Plano, TX (US); Marc Juzkow, Livermore, CA (US)

(73) Assignee: Leyden Energy, Inc., Fremont, CA (US)

(21) Appl. No.: 12/953,335

(22) Filed: Nov. 23, 2010

Related U.S. Application Data
(63) Continuation of application No. PCT/US2009/045723, filed on May 29, 2009.
(60) Provisional application No. 61/057,179, filed on May 29, 2008.

(51) Int. Cl. H01M 10/056; H01M 10/02

(52) U.S. Cl. 429/149; 429/336; 429/339; 429/340; 429/341; 429/344; 429/345; 429/346; 429/203; 429/204; 429/207

(57) ABSTRACT

The present invention provides a lithium-ion electrochemical cell comprising an ionic liquid electrolyte solution and a positive electrode having a carbon sheet current collector.

### CROSS-REFERENCES TO RELATED APPLICATIONS

This application claims priority to and is a continuation of International Patent Application No. PCT/US2009/045723, filed May 29, 2009, which claims the benefit of priority of U.S. Provisional Patent Application No. 61/057,179 filed May 29, 2008. This application expressly incorporates by reference the above International and U.S. Provisional Application in their entirety for all purposes.

### BACKGROUND OF THE INVENTION

There is currently great interest in developing a new generation of high temperature stable, high voltage, non-flammable and durable rechargeable batteries in various applications including consumer electronics and automobile industries.

Conventional electrolytes with organic solvent are high on the list of hazardous chemicals because they are typically volatile liquids that are used in large quantity and produce harmful spills that are difficult to contain. It is known for organic-solvent based electrolytes that a wider stability window is found when inert electrodes are used, like glassy-carbon or platinum, than when electrodes containing active materials are used, like intercalation compounds. In the case of electrodes containing active materials, smaller electrolyte stability windows are found due to interaction of the electrolyte with the active materials. Furthermore, increasing the temperature enhances these interactions, resulting in an even smaller stability window.

Ionic liquids are salts that are liquid at ambient or near ambient temperatures. Unlike conventional organic solvents, ionic liquids are non-volatile, non-flammable, and chemically stable over a wide temperature ranges, up to 500° C. These properties are advantageous to help reduce losses to evaporation, eliminate volatile organic emissions, and improve safety. Other properties of ionic liquids have also proved advantageous. For example, many ionic liquids have a broad temperature range at which they remain liquid and are stable over a broad pH range. This is beneficial for high temperature processes with a demanding pH. Ionic liquids also show the widest electrochemical stability windows of up to 5.5 V, measured between glassy carbon electrodes at 25° C. (see, MacFarlane, et al. Journal of Physical Chemistry B. 1999, 103, 4164).

Therefore, there is a need to develop ionic liquid electrolytes based lithium-ion electrochemical cells and batteries that have high thermal stability, wide electrochemical stability windows, low corrosivity, excellent durability and high ion conductivity. The present invention satisfies these and other needs.

### BRIEF SUMMARY OF THE INVENTION

The present invention provides thermally stable lithium-ion electrochemical cells. The cells include an electrolyte solution, which comprises a lithium compound, an ionic liquid or a mixture of an organic solvent and an ionic liquid. Compared to conventional organic solvents, ionic liquids allow the obtaining of very high electrolyte concentration at ease. Advantageously, the electrochemical cell has high thermal stability, wide electrochemical stability windows, low corrosivity, excellent durability, high working voltage and high ion conductivity. Higher anodic stability of carbon current collector than other common metallic current collectors such as Al and Ni; in conjunction with higher anodic stability of ionic liquids allows for higher voltage cathode active materials to be used which will increase the energy density of the cell.

In one aspect, the present invention provides a lithium-ion electrochemical cell. The cell includes a positive electrode comprising a positive electrode active material and a carbon sheet current collector in electronically conductive contact with the positive electrode material, a negative electrode comprising an negative electrode active material and a current collector in electronically conductive contact with the negative electrode material, an ion permeable separator, and an electrolyte solution in ionically conductive contact with the negative electrode and positive electrode. The electrolyte solution comprises a lithium compound and a solvent selected from an ionic liquid of formula (I) or a mixture of an organic solvent and an ionic liquid of formula (I):

Q⁺E⁻ (I)

Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls and R^{f} is alkyl or alkoxyalkyl. E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻, B⁻(OR^{a1})₂(OR^{a2})₂ and bis[oxalate(2-)-O,O′]borate. The subscript m is 0 or 1. X is N when m is 0. X is C when m is 1. R¹, R² and R³ are each independently an electron-withdrawing group selected from the group consisting of halogen, —CN, —SO₂R^{b}, —SO₂-L^{a}-SO₂N⁻Li⁻SO₂R^{b}, —P(O)(OR^{b})₂, —P(O)(R^{b})₂, —CO₂R^{b} and —H, with the proviso that R¹ and R² are other than hydrogen when m=0, and no more than one of R¹, R² and R³ is hydrogen when m=1. Each R^{a} is independently C₁₋₈perfluoroalkyl. L^{a} is C₁₋₄perfluoroalkylene. Each R^{b} is independently selected from the group consisting of C₁₋₈alkyl, C₁₋₈haloalkyl, C₁₋₈ perfluoroalkyl, perfluorophenyl, aryl, optionally substituted barbituric acid and optionally substituted thiobarbituric acid. At least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene. R^{a1} and R^{a2} are each independently an alkyl. In one embodiment, two R^{a1} groups together with the oxygen atoms to which the two R^{a1} groups are attached and the boron atom to which the oxyen atoms are attached form a five- or six-member ring, which is optionally fused with a six-membered aromatic ring having 0-1 nitrogen heteroatom, and optionally two R^{a2} groups together with the oxygen atoms to which the two R^{a1} groups are attached and the boron atom to which the oxygen atoms are attached form a five- or six-member ring, which is optionally fused with a six-membered aromatic ring having 0-1 nitrogen heteroatom. In some embodiments, at least one positive electrode tab having a first attachment end and a second attachment end, wherein the first attachment end is connected to the positive electrode current collector; optionally, at least one negative electrode tab having a first attachment end and a second attachment end, wherein the first attachment end is connected to the negative electrode current collector.

In another aspect, the present invention provides a battery pack. The battery pack includes a plurality of cells, wherein each cell comprises an ionic liquid of formula (I):

Q⁺E⁻ (I)

wherein Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls and each R^{f} is independently alkyl or alkoxyalkyl. E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻ and bis[oxalate(2-)-O,O′]borate, wherein m is 0 or 1. X is N when m is 0. X is C when m is 1. R¹, R² and R³ are each independently an electron-withdrawing group selected from the group consisting of halogen, —CN, —SO₂R^{b}, —SO₂-L^{a}-SO₂N⁻Li⁺SO₂R^{b}, —P(O)(OR^{b})₂, —P(O)(R^{b})₂, —CO₂R^{b}, —C(O)R^{b} and —H; with the proviso that R¹ and R² are other than hydrogen when m=0, and no more than one of R¹, R² and R³ is hydrogen when m=1. Each R^{a} is independently C₁₋₈perfluoroalkyl. Each R^{b} is independently selected from the group consisting of C₁₋₈alkyl, C₁₋₈haloalkyl, C_{i—}g perfluoroalkyl, perfluorophenyl, aryl, optionally substituted barbituric acid and optionally substituted thiobarbituric acid. At least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene. These and other aspects and advantages of the present invention will become apparent to one of skill in the art from the following detailed description and figures.

### BRIEF DESCRIPTION OF THE DRAWINGS

FIG. 1 illustrates the discharge capacity profile of a full lithium-ion electrochemical cell. The electrolyte solution is 1M LiN(SO₂CF₃)₂ (LiTFSi) in ethylene carbonate (EC)/1-butyl-1-methylpyrrolidinium bis(trifluoromethylsulfonyl)imide, where EC and 1-butyl-1-methylpyrrolidinium bis(trifluoromethylsulfonyl)imide have a weight ratio of 1:1.

FIG. 2 illustrates the discharge capacity profile of an anode half-cell. The electrolyte solution is 1M LiTFSi in ethylene carbonate (EC)/1-butyl-1-methylpyrrolidinium bis(trifluoromethylsulfonyl)imide, where EC and 1-butyl-1-methylpyrrolidinium bis(trifluoromethylsulfonyl)imide have a weight ratio of 1:1.

FIG. 3 illustrates the discharge capacity profile of a cathode half-cell. The electrolyte solution is 1M LiTFSi in ethylene carbonate (EC)/1-butyl-1-methylpyrrolidinium bis(trifluoromethylsulfonyl)imide, where EC and 1-butyl-1-methylpyrrolidinium bis(trifluoromethylsulfonyl)imide have a weight ratio of 1:1.

FIG. 4A illustrates the discharge capacities of anode half-cells with four ionic liquids, where EC and the respective ionic liquid has a weight ratio of 1:1. IL1: 1-Hexyl-3-methylimidazolium bis(trifluoromethylsulfonyl)imide; IL2: 1-Hexyl-3-methylimidazolium bis(trifluoromethylsulfonyl)imide; TEGDME: tetraethylene glycol dimethyl ether; GVL: gamma valero lactone. The lithium compound is 1 M Lithium bis(trifluoromethylsulfonyl)imide (LiTFSi). FIG. 4B illustrates the first cycle coulombic efficiencies of cells having various electrolyte solutions.

FIG. 5A illustrates the comparison of the discharge capacity of 1 M LiTFSi ionic liquid organic solvent full cell and organic solvents full cells, one with 1M LiTFSi; and a second full cell with 1 M LiPF₆, and a theoretical cell, wherein in each solvent mixture, EC consists of 50wt % of the total solvent amount. DMC, another organic solvent, represents dimethyl carbonate. FIG. 5B illustrates the columbic efficiencies of three lithium-ion full cells, comparing a cell comprising an ionic liquid with two cells without ionic liquid.

FIG. 6 illustrates the voltage versus test time profile for the first cycle of the lithium-ion electrochemical cell produced as described in Example 4.

### DETAILED DESCRIPTION OF THE INVENTION

The term “alkyl”, by itself or as part of another substituent, means, unless otherwise stated, a straight or branched chain hydrocarbon radical, having the number of carbon atoms designated (i.e. C₁₋₈ means one to eight carbons). Examples of alkyl groups include methyl, ethyl, n-propyl, isopropyl, n-butyl, t-butyl, isobutyl, sec-butyl, n-pentyl, n-hexyl, n-heptyl, n-octyl, and the like. For each of the definitions herein (e.g., alkyl, alkylene and haloalkyl), when a prefix is not included to indicate the number of main chain carbon atoms in an alkyl portion, the radical or portion thereof will have 20 or fewer main chain carbon atoms.

The term “alkylene” by itself or as part of another substituent means a linear or branched saturated divalent hydrocarbon radical derived from an alkane having the number of carbon atoms indicated in the prefix. For example, (C₁-C₆)alkylene is meant to include methylene, ethylene, propylene, 2-methylpropylene, pentylene, and the like. Perfluoroalkylene means an alkylene where all the hydrogen atoms are substituted by fluorine atoms. Fluoroalkylene means an alkylene where hydrogen atoms are partially substituted by fluorine atoms.

The terms “halo” or “halogen,” by themselves or as part of another substituent, mean, unless otherwise stated, a fluorine, chlorine, bromine, or iodine atom.

The term “haloalkyl,” are meant to include monohaloalkyl and polyhaloalkyl. For example, the term “C₁₋₄ haloalkyl” is mean to include trifluoromethyl, 2,2,2-trifluoroethyl, 4-chlorobutyl, 3-bromopropyl, 3-chloro-4-fluorobutyl and the like.

The term “perfluoroalkyl” means an alkyl where all the hydrogen atoms in the alkyl are substituted by fluorine atoms. Examples of perfluoroalkyl include —CF₃, —CF₂CF₃, —CF₂—CF₂CF₃, —CF(CF₃)₂, —CF₂CF₂CF₂CF₃, —CF₂CF₂CF₂CF₂CF₃ and the like. The term “perfluoroalkylene” means a divalent perfluoroalkyl.

The term “aryl” means a monovalent monocyclic, bicyclic or polycyclic aromatic hydrocarbon radical of 5 to 10 ring atoms which is unsubstituted or substituted independently with one to four substituents, preferably one, two, or three substituents selected from alkyl, cycloalkyl, cycloalkyl-alkyl, halo, cyano, hydroxy, alkoxy, amino, acylamino, mono-alkylamino, di-alkylamino, haloalkyl, haloalkoxy, heteroalkyl, COR (where R is hydrogen, alkyl, cycloalkyl, cycloalkyl-alkyl, phenyl or phenylalkyl, aryl or arylalkyl), —(CR′R″)ₙ—COOR (where n is an integer from 0 to 5, R′ and R″ are independently hydrogen or alkyl, and R is hydrogen, alkyl, cycloalkyl, cycloalkylalkyl, phenyl or phenylalkyl aryl or arylalkyl) or —(CR′R″)ₙ—CONR′″R″″ (where n is an integer from 0 to 5, R′ and R″ are independently hydrogen or alkyl, and R′″ and R″″ are each independently hydrogen, alkyl, cycloalkyl, cycloalkylalkyl, phenyl or phenylalkyl, aryl or arylalkyl). More specifically the term aryl includes, but is not limited to, phenyl, biphenyl, 1-naphthyl, and 2-naphthyl, and the substituted forms thereof

The term “heteroaryl” refers to aryl groups (or rings) that contains from one to five heteroatoms selected from N, O, or S, wherein the nitrogen and sulfur atoms are optionally oxidized, and the nitrogen atom(s) are optionally quaternized. Non-limiting examples of heteroaryl groups include pyridyl, pyridazinyl, pyrazinyl, pyrimindinyl, triazinyl, quinolinyl, quinoxalinyl, quinazolinyl, cinnolinyl, phthalaziniyl, benzotriazinyl, purinyl, benzimidazolyl, benzopyrazolyl, benzotriazolyl, benzisoxazolyl, isobenzofuryl, isoindolyl, indolizinyl, benzotriazinyl, thienopyridinyl, thienopyrimidinyl, pyrazolopyrimidinyl, imidazopyridines, benzothiaxolyl, benzofuranyl, benzothienyl, indolyl, quinolyl, isoquinolyl, isothiazolyl, pyrazolyl, indazolyl, pteridinyl, imidazolyl, triazolyl, tetrazolyl, oxazolyl, isoxazolyl, thiadiazolyl, pyrrolyl, thiazolyl, furyl, thienyl and the like.

The term “cycloalkyl” refers to hydrocarbon rings having the indicated number of ring atoms (e.g., C₃₋₆cycloalkyl) and being fully saturated or having no more than one double bond between ring vertices. One or two C atoms may optionally be replaced by a carbonyl. “Cycloalkyl” is also meant to refer to bicyclic and polycyclic hydrocarbon rings such as, for example, bicyclo[2.2.1]heptane, bicyclo[2.2.2]octane, etc.

The term “heterocycloalkyl” refers to a cycloalkyl group that contain from one to five heteroatoms selected from N, O, and S, wherein the nitrogen and sulfur atoms are optionally oxidized, and the nitrogen atom(s) are optionally quaternized, the remaining ring atoms being C. The heterocycloalkyl may be a monocyclic, a bicyclic or a polycylic ring system of 3 to 12, preferably 5 to 8, ring atoms in which one to five ring atoms are heteroatoms. The heterocycloalkyl can also be a heterocyclic alkyl ring fused with an aryl or a heteroaryl ring. Non limiting examples of heterocycloalkyl groups include pyrrolidine, piperidiny, imidazolidine, pyrazolidine, butyrolactam, valerolactam, imidazolidinone, hydantoin, dioxolane, phthalimide, piperidine, 1,4-dioxane, morpholine, thiomorpholine, thiomorpholine-S-oxide, thiomorpholine-S,S-oxide, piperazine, pyran, pyridone, 3-pyrroline, thiopyran, pyrone, tetrahydrofuran, tetrahydrothiophene, quinuclidine, and the like. A heterocycloalkyl group can be attached to the remainder of the molecule through a ring carbon or a heteroatom.

The above terms (e.g., “alkyl” and “aryl”), in some embodiments, will include both substituted and unsubstituted forms of the indicated radical. Preferred substituents for each type of radical are provided below. For brevity, the terms aryl and heteroaryl will refer to substituted or unsubstituted versions as provided below, while the term “alkyl” and related aliphatic radicals is meant to refer to unsubstituted version, unless indicated to be substituted.

Substituents for the alkyl radicals (including those groups often referred to as alkylene and heterocycloalkyl) can be a variety of groups selected from: -halogen, —OR′, —NR′R″, —SR′, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, R′, —CN and —NO₂ in a number ranging from zero to (2 m′+1), where m′ is the total number of carbon atoms in such radical. R′, R″ and R′″ each independently refer to hydrogen, unsubstituted C₁₋₈ alkyl, unsubstituted heteroalkyl, unsubstituted aryl, perfluorophenyl, aryl substituted with 1-3 halogens, C₁₋₈perfluoroalkyl, partially fluorinated alkyls such as C₁₋₈alkyl substituted with from 1-17 fluorine atoms, C₁₋₈ alkoxy or C₁₋₈ thioalkoxy groups, or unsubstituted aryl-C₁₋₄ alkyl groups. When R′ and R″ are attached to the same nitrogen atom, they can be combined with the nitrogen atom to form a 3-, 4-, , 5-, 6-, or 7-membered ring. For example, —NR′R″ is meant to include 1-pyrrolidinyl and 4-morpholinyl. The term “acyl” as used by itself or as part of another group refers to an alkyl radical wherein two substitutents on the carbon that is closest to the point of attachment for the radical is replaced with the substitutent ═O (e.g., —C(O)CH₃, —C(O)CH₂CH₂OR′ and the like).

Substituents for the aryl groups are varied and are generally selected from: -halogen, —OR′, —OC(O)R′, —NR′R″, —SR′, —R′, —CN, —NO₂, —CO₂R′, —CONR′R″, —C(O)R′, —OC(O)NR′R″, —NR″C(O)R′, —NR′C(O)₂R′, —NR′—C(O)NR″R″′, —NH—C(NH₂)═NH, —NR′C(NH₂)═NH, —NH—C(NH₂)═NR′, —S(O)R′, —S(O)₂R′, —S(O)₂NR′R″, —NR′S(O)₂R″, —N₃, perfluoro(C₁-C₄)alkoxy, and perfluoro(C₁-C₄)alkyl, perfluorophenyl, and C₁₋₄alkykl substituted with from 1-9 fluorine atoms, in a number ranging from zero to the total number of open valences on the aromatic ring system; and where R′, R″ and R′″ are independently selected from hydrogen, C₁₋₈ alkyl, unsubstituted aryl and heteroaryl, (unsubstituted aryl)-C₁₋₄ alkyl, and unsubstituted aryloxy-C₁₋₄ alkyl.

The term “positive electrode” refers to one of a pair of rechargeable lithium-ion cell electrodes that under normal circumstances and when the cell is fully charged will have the highest potential. This terminology is retained to refer to the same physical electrode under all cell operating conditions even if such electrode temporarily (e.g., due to cell overdischarge) is driven to or exhibits a potential below that of the other (the negative) electrode.

The term “negative electrode” refers to one of a pair of rechargeable lithium-ion cell electrodes that under normal circumstances and when the cell is fully charged will have the lowest potential. This terminology is retained to refer to the same physical electrode under all cell operating conditions even if such electrode is temporarily (e.g., due to cell overdischarge) driven to or exhibits a potential above that of the other (the positive) electrode.

The term “ionic liquid” means a salt comprising a cation and an anion. The salt is a liquid at ambient or near ambient temperatures. Preferably, the cations are organic cations.

In one aspect, the present invention provides a lithium-ion electrochemical cell. The cell includes a positive electrode comprising a positive electrode active material and a carbon sheet current collector in electronically conductive contact with the positive electrode material; a negative electrode comprising an negative electrode active material and a current collector in electronically conductive contact with the negative electrode material; an ion permeable separator; and an electrolyte solution in ionically conductive contact with the negative electrode and positive electrode, wherein the electrolyte solution comprises a lithium compound and a solvent selected from an ionic liquid of formula (I) or a mixture of an organic solvent and an ionic liquid of formula (I):

Q⁺E⁻ (I)

Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 1optionally substituted alkyls and each R^{f} is independently an alkyl or an alkoxyalky. E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻, B⁻(OR^{a1})₂(OR^{a2})₂ and bis[oxalate(2-)-O,O′]borate, wherein m is 0 or 1. In one embodiment, the substituent for alkyl can be alkoxy or any substituents as defined above. X is N when m is 0. X is C when m is 1. R¹, R² and R³ are each independently an electron-withdrawing group selected from the group consisting of halogen, —CN, —SO₂R^{b}, —SO₂-L^{a}-SO₂N⁻Li⁺SO₂R^{b}, —P(O)(OR^{b})₂, —P(O)(R^{b})₂, —CO₂R^{b}, —C(O)R^{b} and —H, with the proviso that R¹ and R² are other than hydrogen when m=0, and no more than one of R¹, R² and R³ is hydrogen when m=1. In one embodiment, halogen is F⁻. Each R^{a} is independently C₁₋₈perfluoroalkyl. L^{a} is C₁₋₄perfluoroalkylene. Each R^{b} is independently selected from the group consisting of C₁₋₈alkyl, C₁₋₈haloalkyl, C₁₋₈perfluoroalkyl, perfluorophenyl, aryl, optionally substituted barbituric acid and optionally substituted thiobarbituric acid. At least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene. R^{a1} and R^{a2} are each independently an alkyl. In certain instances, R^{a}, R^{b} and R^{c} are each independently selected from perfluorophenyl and phenyl optionally substituted with from 1-3 members selected from —F or C₁₋₄perfluoroalkyl. In one instance, two R^{a1} groups taken together with the oxygen atoms to which the two R^{a1} groups are attached and the boron atom to which the two oxygen atoms are attached form a five- or six-member ring, which is optionally fused with a six-membered aromatic ring having 0-1 nitrogen heteroatom, and optionally two R^{a2} groups taken together with the oxygen atoms to which the two R^{a1} groups are attached and the boron atom to which the two oxygen atoms are attached form a five- or six-member ring, which is optionally fused with a six-membered aromatic ring having 0-1 nitrogen heteroatom.

In one group of embodiments of compounds of formula (I), cation Q⁺ has a formula (Ia):

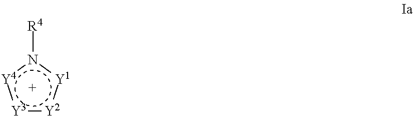

wherein R⁴ is —H, a C₁₋₂₀ alkyl or alkoxyalkyl, optionally substituted with from 1-3 members selected from the group consisting of halogen and C₁₋₄perfluoroalkyl; Y¹ and Y³ are each independently selected from the group consisting of ═N— and ═CR^{d}—; Y² and Y⁴ are each independently selected from the group consisting of ═N—, —O—, —S—, —NR^{d}— and ═CR^{d}—, with the proviso that Y² and Y⁴ are neither simultaneously a member selected from the group consisting of —NR^{d}— and ═CR^{d}—, nor simultaneously a member selected from the group consisting of —O—, —NR^{d}— and —S—; wherein each R^{d} is independently —H, an alkyl or an alkoxyalky. In certain instances, Y¹, Y², Y³ and Y⁴ are ═N—. In certain other instances, Y¹, Y², Y³ and Y⁴ are ═CR^{d}—. In yet other instances, Y¹ is ═CR^{d}—, Y² is ═N—, Y³ is ═N— or ═CR^{d}— and Y⁴ is ═N—, —O—, —S— or ═CR^{d}—. In still other instances, Y¹ is ═CR^{d}—, Y² is —O— or —S—, Y³ is ═N— or ═CR^{d}— and Y⁴ is ═N— or ═CR^{d}—. In other instances, Y¹ is ═CR^{d}—, Y² is ═CR^{d}—, Y³ is ═N— or ═CR^{d}— and Y⁴ is ═N—, —O—, —S— or ═CR^{d}—. In yet other instances, Y¹ is ═N—, Y² is ═N—, Y³ is ═N— or ═CR^{d}— and Y⁴ is ═N—, —O—, —S— or ═CR^{d}—. In still other instances, Y¹ is ═N—, Y² is —O— or —S—, Y³ is ═N— or ═CR^{d}— and Y⁴ is ═N— or ═CR^{d}—. In other instances, Y¹ is ═N—, Y² is ═CR^{d}—, Y³ is ═N— or ═CR^{d}— and Y⁴ is ═O—, —O—, —S— or ═CR^{d}—.

In another group of embodiments of compounds of formula (I), cation Q⁺ has a subformula (Ia-1):

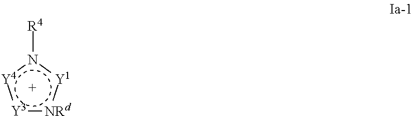

wherein the substituents Y¹, Y³, Y⁴, R⁴ and R^{d} are as defined above. In certain instances, Y¹ is ═N— or ═CR^{d}. In one occurrence, Y¹ is ═CR^{d}. In certain other instances, Y⁴ is —O—. In yet other instances, R⁴ is H. In yet other instances, Y¹, Y³ and Y⁴ are ═CH—, R⁴ is methyl and R^{d} is C₁₋₈alkyl or C₁₋₈alkoxyalkyl.

In yet another group of embodiments of compounds of formula (I), cation Q⁺ has a formula (Ib):

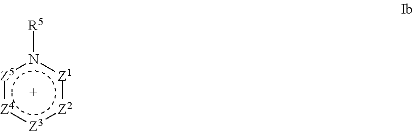

wherein R⁵ is —H , C₁₋₂₀alkyl or alkoxyalkyl, optionally substituted with from 1-3 members selected from the group consisting of halogen and C₁₋₄perfluoroalkyl; and Z¹, Z², Z³, Z⁴ and Z⁵ are each independently selected from the group consisting of ═N— and ═CR^{e}—, wherein each R^{e} is independently selected from the group consisting of —H and alkyl, or optionally the R^{e} substituents on the adjacent carbons are combined with the atoms to which they are attached form a 5- or 6-membered ring having from 0-2 addition heteroatoms as ring members selected from O, N or S. In certain instances, Z¹ is ═N. In one occurrence, Z², Z³, Z⁴ and Z⁵ are ═CR^{e}—. In certain other instances, Z² is ═N—. In one occurrence, Z¹, Z³, Z⁴ and Z⁵ are ═CR^{e}—. In yet other instances, R^{e} instances, Z³ is ═N—. In one occurrence, Z¹, Z², Z⁴ and Z⁵ are ═CR^{e}—. In still other instances, is —H.

In still another group of embodiments of compounds of formula (I), cation Q⁺ has a formula (Ic):

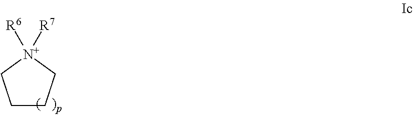

wherein the subscript p is 1 or 2; and R⁶ and R⁷ are each independently H or an optionally substituted C₁₋₈alkyl. In certain instances, p is 1 and R⁶ and R⁷ are each independently an optionally substituted C₁₋₈alkyl. In one occurrence, R⁶ and R⁷ are each independently a C₁₋₈alkyl. In certain other instances, p is 1, R⁶ is methyl and R⁷ is C₁₋₈alkyl. In one occurrence, R⁷ is butyl. In yet other instances, p is 2.

In another group of embodiments of compounds of formula (I), cation Q⁺ is selected from the group consisting of:

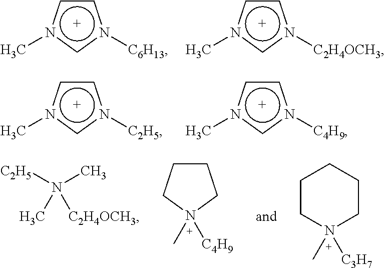

The organic cations used in the present invention include at least one cation selected from the group consisting of, for example, imidazolium ions such as dialkyl imidazolium cation and trialkyl imidazolium cation, tetraalkyl ammonium ion, alkyl pyridinium ion, dialkyl pyrrolidinium ion, and dialkyl piperidinium ion. Organic cations such as imidazolium ion, dialkyl piperidinium ion and tetraalkyl ammonium ion are excellent in electrical conductivity. These organic cations are ranked in the order of imidazolium ion>>dialkyl piperidinium ion>tetraalkyl ammonium ion, if arranged in the order of the electrical conductivity.

In one group of embodiments of compounds of formula (I), anion E⁻ is selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻, B⁻(OR^{a1})₂(OR^{a2})₂ and bis[oxalate(2-)-O,O′]borate. The substituents R¹, R², R³, R^{a1},R^{a2} and subscript m are as defined above. In certain instances, E⁻ is CF₃SO₂X⁻R²(R³)ₘ. In other instances, E⁻ is selected from the group consisting of (CF₃SO₂)₃C⁻, (CF₃SO₂)₂CH⁻, CF₃(CH₂)₃SO₃⁻, (CF₃SO₂)₂N⁻, (CN)₂N⁻, SO₄⁻, CF₃SO₃⁻, NC—S⁻, BF₄⁻, PF₆⁻, (CF₃CF₂)₃P⁻F₃, CF₃CO₂⁻, SO₄⁻ and bis[oxalate(2-)-O,O′]borate. In other instances, E⁻ is PF₆⁻, BF₄⁻ or ClO₄⁻. In yet other instances, E⁻ is a borate compound having the formulas:

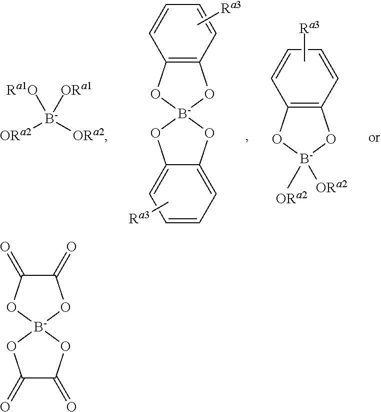

wherein R^{a1} and R^{a2} groups are as defined above and each R^{a1} is independently —H or alkyl. One of the ordinary skill in the art will understand that these anions can also be used to form lithium compounds.

In one embodiment, the lithium-ion electrochemical cell contains a lithium compound having formula: Li⁺E⁻, wherein E⁻ is as defined above. In certain instances, E⁻ is R¹—X⁻R²(R³)ₘ, BF₄⁻, PF₆⁻, ClO₄⁻ or SO₄⁻. In other instances, E⁻ is BF₄⁻, PF₆⁻, ClO₄⁻, (FSO₂)₂N—, AsF₆⁻, or SO₄⁻. In another embodiment, the lithium-ion electrochemical cell contains a lithium compound having formula (II): R¹—X⁻(Li⁺)R²(R³)ₙ, wherein: n is 0 or 1; X is N when n is 0; X is C when n is 1; R¹, R² and R³ are each independently an electron-withdrawing group selected from the group consisting of halogen, —CN, —SO₂R^{b}, —SO₂(—R^{b}—SO₂Li⁺)SO₂—R^{b}, —P(O)(OR^{b})₂, —P(O)(R^{b})₂, —CO₂R^{b}, —C(O)R^{b} and —H; with the proviso that R¹ and R² are other than hydrogen when n=0, and no more than one of R¹, R² and R³ is hydrogen when n=1; and wherein each R^{b} is independently selected from the group consisting of C₁₋₈ alkyl, C₁₋₈haloalkyl, C₁₋₈ perfluoroalkyl, perfluorophenyl, aryl, optionally substituted barbituric acid and optionally substituted thiobarbituric acid, wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is C₁₋₈ alkyl, perfluorophenyl or C₁₋₈ perfluoroalkyl. Preferably, the compound has an oxidation potential above the recharged potential of the positive electrode. In one instance, the lithium compound has the formula: CF₃SO₂N⁻(Li⁺)SO₂CF₃.

The electrolyte solvents can be pure ionic liquid or a mixture of ionic liquids with organic solvents. Suitable organic solvents include carbonates and lactones. Organic carbonates and lactones include compounds having the formula: R^{x}OC(═O)OR^{y}, wherein R^{x} and R^{y} are each independently selected from the group consisting of C₁₋₄alkyl and C₃₋₆cycloalkyl, or together with the atoms to which they are attached to form a 4- to 8-membered ring, wherein the ring carbons are optionally substituted with 1-2 members selected from the group consisting of halogen, C₁₋₄alkyl and C₁₋₄haloalkyl. In one embodiment, the organic carbonates include propylene carbonate, dimethyl carbonate, ethylene carbonate, diethyl carbonate, ethylmethyl carbonate and a mixture thereof as well as many related species. The lactones can be β-propiolactone, γ-butyrolactone, δ-valerolactone, ε-caprolactone, hexano-6-lactone or a mixture thereof, each of which is optionally substituted with from 1-4 members selected from the group consisting of halogen, C₁₋₄ alkyl and C₁₋₄haloalkyl.

In certain embodiments, the electrolyte solvent is a mixture of an ionic liquid and an organic solvent. The organic solvent and the ionic liquid can have a volume ratio from about 1:100 to about 100:1. In other embodiments, the volume ratio is from about 1:10 to about 10:1. Exemplary ratios organic solvent and ionic liquid include 1:10, 1:9, 1:8, 1:7, 1:6, 1:5, 1:4, 1:3, 1:2, 1:1, 2:1, 3:1, 4:1, 5:1, 6:1, 7:1, 8:1, 9:1 and 10:1.

The electrolyte solution suitable for the practice of the invention is formed by combining the lithium compounds of formula (II) with an electrolyte solvent comprising ionic liquids of formula (I). For example, lithium imide such as lithium bis(trifluorosulfonyl)imide (LiTFSI) or methide salts of compounds of formula (II) are optionally combined with a co-salt selected from LiPF₆, LiBF₄, LiAsF₆, LiB(C₂O₄)₂, (Lithium bis(oxalato)borate), LiF or LiClO₄, along with the electrolyte solvent/ionic liquid by dissolving, slurrying or melt mixing as appropriate to the particular materials. The present invention is operable when the concentration of the imide or methide salt is in the range of 0.2 to up to 3 molar, but 0.5 to 2 molar is preferred, with 0.8 to 1.2 molar most preferred. Depending on the fabrication method of the cell, the electrolyte solution may be added to the cell after winding or lamination to form the cell structure, or it may be introduced into the electrode or separator compositions before the final cell assembly.

In some embodiments, the current collector for the electrode is a non-metal conductive substrate. Exemplary non-metal current collectors include, but are not limited to, a carbon sheet such as a graphite sheet, a carbon fiber sheet, a carbon foam, a carbon nanotube film, and a mixture of the foregoing or other conducting polymeric materials. Those of skill in the art will know of these conducting polymeric materials.

In some embodiments, the electrochemical cell has one or more tabs attached to each electrode. In one instance, each electrode has at least one tab. In another instance, each electrode has multiple tabs. In yet another instance, the positive electrode has multiple metal tabs attached to the positive electrode on the carbon current collector. For example, each electrode can have from 2 to 20 tabs. The positive and the negative electrode can have different numbers of tabs. The tabs can be made of a single metal, a metal alloy or a composite material. Preferably, the tabs are metallic. Suitable metals include, but are not limited to, iron, stainless steel, copper, nickel, chromium, zinc, aluminum, tin, gold, tantalum, niobium, hafnium, zirconium, vanadium, indium, cobalt, tungsten, beryllium and molybdenum and alloys thereof or an alloy thereof. Preferably, the metal is anticorrosive. The tabs can have anticorrosive coatings made of any of the above metals, anodizing and oxide coatings, conductive carbon, epoxy and glues, paints and other protective coatings. The coatings can be nickel, silver, gold, palladium, platinum, rhodium or combinations thereof for improving conductivity of the tabs. In one instance, the tabs are made of copper, aluminum, tin or alloys thereof. The tabs can have various shapes and sizes. In general, the tabs are smaller than the current collector to which the tabs are attached to. In one embodiment, the tabs can have a regular or an irregular shape and form. In one instance, the tabs have L-shape, I-shape, U-shape, V-shape, inverted T-shape, rectangular-shape or combinations of shapes. Preferably, the tabs are metal strips fabricated into a particular shape or form. The alloys can be a combinations of metals described herein or formed by combining the metals described above with other suitable metals known to persons of skill in the art.

Typically, each of the tabs has a first attachment end and a second attachment end. The first attachment end is an internal end for attaching to a current collector and the second attachment end is an external or an open end for connecting to an external circuit. The first attachment end can have various shapes and dimensions. In one embodiment, the first attachment end of the tabs has a shape selected from the group consisting of a circle, an oval, a triangle, a square, a diamond, a rectangle, a trapezoidal, a U-shape, a V-shape, an L-shape, a rectangular-shape and an irregular shape. In one instance, the tabs are strips with the first attachment end having a dimension of at least 500 micrometers in width and 3 mm in length. In one embodiment, the attachment end has a dimension of at least 0.25 mm². In certain instances, the dimension is from about 1 mm² to about 500 mm². The second attachment end can connect either directly to an external circuit or through a conductive member. The conductive member can be a metal tab, rod or wire. The suitable metal can be copper, aluminum, iron, stainless steel, nickel, zinc, chromium, tin, gold, tantalum, niobium, hafnium, zirconium, vanadium, indium, cobalt, tungsten, beryllium and molybdenum and alloys thereof or an alloy thereof

In one embodiment, the tabs are in direct contact with the current collector. In another embodiment, the tabs are in contact with the current collector through a conductive layer. The conductive layer can be attached to the surface of the tab, for example, by depositing a layer of carbon black on the tab. The conductive layer can include a conductive filler and a binder. In one instance, the conductive filler is selected from the group consisting of carbon black, conducting polymers, carbon nanotubes and carbon composite materials. Suitable binders include, but are not limited to, a polymer, a copolymer or a combination thereof. Exemplary binders include, but are not limited to, polymeric binders, particularly gelled polymer electrolytes comprising polyacrylonitrile, poly(methylmethacrylate), poly(vinyl chloride), and polyvinylidene fluoride and copolymers thereof. Also, included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers comprising partially or fully fluorinated polymer backbones, and having pendant groups comprising fluorinated sulfonate, imide, or methide lithium salts. Preferred binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers comprising monomer units of polyvinylidene fluoride and monomer units comprising pendant groups comprising fluorinated carboxylate, sulfonate, imide, or methide lithium salts.

The tabs can be attached to the positive electrode or the negative electrode using a process selected from the group consisting of riveting, conductive adhesive lamination, hot press, ultrasonic press, mechanical press, staking, crimping, pinching, and a combination thereof. The process offers the advantages of providing strong binding to the current collector and yet maintaining high electrical conductivity and low impedance across the junction of tab and the current collector. The process is particularly suitable for attaching metal tabs to carbon sheet.

In one embodiment, the first attachment end includes an array of preformed micro indentations. The tabs can have an indentation density from about 1 to about 100 per square millimeter. The indentations can be produced by either a micro indentation hand tool or an automatic indentation device. In one instance, each indentation is about 1-100 _{[}tm in depth, such as 1, 2, 3, 4, 5, 6, 7, 8, 9, 10, 20, 30, 40, 50, 60, 70, 80, 90 or 100 micrometers and about 1-500 μm in dimension, such as 1, 10, 20, 30, 40, 50, 60, 70, 80, 90, 100, 120, 140, 160, 180, 200, 250, 300, 400, 450, 500 micrometers. The micro indentations can be either evenly or randomly spaced.

The tabs having an array of micro indentations are attached to the current collector via mechanical pressing or riveting to provide a close contact between the tabs and the current collector. Alternatively, the tabs are joint to the current collector through a conductive adhesive layer or staking

In another embodiment, the first attachment end of the tabs includes an array of preformed micro openings having a plurality of protrusions, such as protruding edges. In one instance, the protrusions are sharp edges. The protrusions can be either generated during the process of making micro openings or prepared by a separate fabrication process. The protrusions extend from about 0.01 mm to about 10 mm above the surface of the tabs and can have various shapes. For example, the protrusions can be triangular, rectangular or circular. The micro openings can have a dimension from micrometers to millimeters. In certain instances, the protrusions extend between about 0.01 mm to 0.04 mm, such as about 0.01, 0.02, 0.03, or 0.04 mm above the surface of the tabs. Preferably, the openings have a dimension of about 1-1000 μm. In one embodiment, the micro openings are evenly spaced. In another embodiment, the openings are randomly distributed. The micro openings can have various shapes. In one embodiment, the micro openings have a shape selected from the group consisting of a circle, an oval, a triangle, a square, a diamond, a rectangle, a trapezoidal, a rhombus, a polygon and an irregular shape.

The tabs having an array of micro openings with protrusions are welded to the current collector through a conductive adhesive layer or by staking, mechanical pressing, staking, riveting or a combination of processes and techniques. The electrically conductive adhesives are generally known to persons of skill in the art. For example, certain conductive adhesives are commercially available from 3M corporation, Aptek laboratories, Inc. and Dow Corning. Exemplary electrically conductive adhesive include, but are not limited to, urethane adhesive, silicone adhesive and epoxy adhesive.

The tabs applicable for the positive electrode as described above can also be used for the negative electrode. In one embodiment, the negative electrode has a carbon current collector.

In one embodiment, the pores in the carbon current collector can be sealed with resins, for example, by treating, contacting of the carbon current collector with resins. The resins can be conductive resins or non-conductive resins known to a person of skill in the art. Exemplary conductive resins are described in U.S. Pat. Nos. 7,396,492, 7,338,623, 7,220,795, 6,919,394, 6,894,100, 6,855,407, 5,371,134, 5,093,037, 4,830,779, 4,772,422, 6,565,772 and 6,284,817. Exemplary non-conductive resins, for example, in adhering, sealing and coating include, but are not limited to, epoxy resin, polyimide resin and other polymer resins known to persons skill in the art.

In one embodiment, the present invention provides a positive electrode, which includes electrode active materials and a current collector. The positive electrode has an upper charging voltage of 3.5-4.5 volts versus a Li/Li⁺ reference electrode. The upper charging voltage is the maximum voltage to which the positive electrode may be charged at a low rate of charge and with significant reversible storage capacity. In some embodiments, cells utilizing positive electrode with upper charging voltages from 3-5.8 volts versus a Li/Li⁺ reference electrode are also suitable. In certain instances, the upper charging voltages are from about 3-4.2 volts, 4.0-5.8 volts, preferably, 4.5-5.8 volts. In certain instances, the positive electrode has an upper charging voltage of about 5 volts. For example, the cell can have a charging voltage of 4.9, 5.0, 5.1, 5.2, 5.3, 5.4, 5.5, 5.6, 5.7 or 5.8 volts. A variety of positive electrode active materials can be used. Non-limiting exemplary electrode active materials include transition metal oxides, phosphates and sulfates, and lithiated transition metal oxides, phosphates and sulfates.

In some embodiments, the electrode active materials are oxides with empirical formula LiₓMO₂, where M is a transition metal ion selected from the group consisting of Mn, Fe, Co, Ni, Al, Mg, Ti, V, and a combination thereof, with a layered crystal structure, the value x may be between about 0.01 and about 1, suitably between about 0.5 and about 1, more suitably between about 0.9 to 1. In other embodiments, the electrode active materials are oxides with the formula LiₓMₐ¹M_{b}²M_{c}³O₂, where M¹, M², and M³ are each independently a transition metal ion selected from Mn, Fe, Co, Ni, Al, Mg, Ti, or V. The subscripts a, b and c are each independently a real number between about 0 and 1 (0≦a≦1; 0≦b≦1; 0≦c≦1; 0.01≦x≦1), with the proviso that a+b+c is 1. In certain instances, the electrode active materials are oxides with empirical formula LiₓNiₐCo_{b}Mn_{c}0₂, wherein the subscript x is between 0.01 and 1, for example, x is 1; the subscripts a, b and c are each independently 0, 0.1, 0.2, 0.3, 0.4, 0.5, 0.6, 0.7, 0.9 or 1, with the proviso that a+b+c is 1. In other instances, the subscripts a, b and c are each independently from about 0-0.5, 0.1-0.6, 0.4-0.7, 0.5-0.8, 0.5-1 or 0.7-1 with the proviso that a+b+c is 1. In yet other embodiments, the active materials are oxides with empirical formula Li₁₊ₓA_{y}M_{2-y}O₄, where A and M are each independently a transition metal ions selected from the group consisting of Fe, Mn, Co, Ni, Al, Mg, Ti, V, and a combination thereof, with a spinel crystal structure, the value x may be between about −0.11 and 0.33, suitably between about 0 and about 0.1, the value of y may be between about 0 and 0.33, suitably between 0 and 0.1. In one embodiment, A is Ni, x is 0 and y is 0.5. In yet some other embodiments the active materials are vanadium oxides such as LiV₂O₅, LiV₆O₁₃, or the foregoing compounds modified in that the compositions thereof are nonstoichiometric, disordered, amorphous, overlithiated, or underlithiated forms such as are known in the art. The suitable positive electrode-active compounds may be further modified by doping with less than 5% of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³ Co³⁺, or Mn³⁺, and the like. In other embodiments, positive electrode active materials suitable for the positive electrode composition include lithium insertion compounds with olivine structure such as LiₓMXO₄ where M is a transition metal ions selected from the group consisting of Fe, Mn, Co, Ni, and a combination thereof, and X is a selected from a group consisting of P, V, S, Si and combinations thereof, the value of the value x may be between about 0 and 2. In certain instances, the compound is LiMXO₄. In some embodiments, the lithium insertion compounds include LiMnPO₄, LiVPO₄, LiCoPO₄ and the like. In other embodiments, the active materials with NASICON structures such as YₓM₂(XO₄)₃, where Y is Li or Na, or a combination thereof, M is a transition metal ion selected from the group consisting of Fe, V, Nb, Ti, Co, Ni, Al, or the combinations thereof, and X is selected from a group of P, S, Si, and combinations thereof and value of x between 0 and 3. The examples of these materials are disclosed by J. B. Goodenough in “Lithium Ion Batteries” (Wiley-VCH press, Edited by M. Wasihara and O. Yamamoto). Particle size of the electrode materials are preferably between 1 nm and 100 μm, more preferably between 10 nm and 100 um, and even more preferably between 1 μm and 100 μm.

In other embodiments, the electrode active materials are oxides such as LiCoO₂, spinel LiMn₂O₄, chromium-doped spinel lithium manganese oxides LiₓCr_{y}Mn₂O₄, layered LiMnO₂, LiNiO₂, LiNiₓCo₁₋ₓO₂ where x is 0<x<1, with a preferred range of 0.5<x<0.95, and vanadium oxides such as LiV₂O₅, LiV₆O₁₃, or the foregoing compounds modified in that the compositions thereof are nonstoichiometric, disordered, amorphous, overlithiated, or underlithiated forms such as are known in the art. The suitable positive electrode-active compounds may be further modified by doping with less than 5% of divalent or trivalent metallic cations such as Fe²⁺, Ti²⁺, Zn²⁺, Ni²⁺, Co²⁺, Cu²⁺, Mg²⁺, Cr³⁺, Fe³⁺, Al³⁺, Ni³⁺, Co³⁺, or Mn³⁺, and the like. In yet other embodiments, positive electrode active materials suitable for the positive electrode composition include lithium insertion compounds with olivine structure such as LiFePO₄ and with NASICON structures such as LiFeTi(SO₄)₃, or those disclosed by J. B. Goodenough in “Lithium Ion Batteries” (Wiley-VCH press, Edited by M. Wasihara and O. Yamamoto). In still other embodiments, electrode active materials include LiFePO₄, LiMnPO₄, LiVPO₄, LiFeTi(SO₄)₃, LiNiₓMn₁₋ₓO₂, LiNiₓCo_{y}Mn_{1-x-y}O₂ and derivatives thereof, wherein x is 0<x<1 and y is 0<y<1. In certain instances, x is between about 0.25 and 0.9. In one instance, x is ⅓ and y is ⅓. Particle size of the positive electrode active material should range from about 1 to 100 microns.

In some preferred embodiments, transition metal oxides such as LiCoO₂, LiMn₂O₄, LiNiO₂, LiNiₓMn₁₋ₓO₂, LiNiₓCo_{y}Mn_{1-x-y}O₂ and their derivatives, where x is 0<x<1 and y is 0<y<1. LiNiₓMn₁₋ₓO₂ can be prepared by heating a stoichiometric mixture of electrolytic MnO₂, LiOH and nickel oxide to about 300 to 400° C. In certain embodiments, the electrode active materials are xLi₂MnO₃(1−x)LiMO₂ or LiM′PO₄, where M is selected from Ni, Co, Mn, LiNiO₂ or LiNiₓCo₁₋ₓO₂; M′ is selected from the group consisting of Fe, Ni, Mn and V; and x and y are each independently a real number between 0 and 1. LiNiₓCo_{y}Mn_{1-x-y}O₂ can be prepared by heating a stoichiometric mixture of electrolytic MnO₂, LiOH, nickel oxide and cobalt oxide to about 300 to 500° C. The positive electrode may contain conductive additives from 0% to about 90%. In one embodiment, the subscripts x and y are each independently selected from 0.1, 0.15, 0.2, 0.25, 0.3, 0.35, 0.4, 0.45, 0.5, 0.55, 0.6, 0.65, 0.7, 0.75, 0.8, 0.85, 0.9 or 0.95. x and y can be any numbers between 0 and 1 to satisfy the charge balance of the compounds LiNiₓMn₁₋ₓO₂ and LiNiₓCo_{y}Mn_{1-x-y}O₂.

Representative positive electrodes and their approximate recharged potentials include FeS₂ (3.0 V vs. Li/Li+), LiCoPO₄ (4.8 V vs. Li/Li+), LiFePO₄ (3.45 V vs. Li/Li+), Li₂FeS₂ (3.0 V vs. Li/Li+), Li₂FeSiO₄ (2.9 V vs. Li/Li+), LiMn₂O₄ (4.1 V vs. Li/Li+), LiMnPO₄ (4.1 V vs. Li/Li+), LiNiPO₄ (5.1 V vs. Li/Li+), LiV₃O₈ (3.7 V vs. Li/Li+), LiV₆O₁₃ (3.0 V vs. Li/Li+), LiVOPO₄ (4.15 V vs. Li/Li+), LiVOPO₄F (4.3 V vs. Li/Li+), Li₃V₂(PO₄)₃ (4.1 V (2 Li) or 4.6 V (3 Li) vs. Li/Li+), MnO₂ (3.4 V vs. Li/Li+), MoS₃ (2.5 V vs. Li/Li+), sulfur (2.4 V vs. Li/Li+), TiS₂(2.5 V vs. Li/Li+), TiS₃ (2.5 V vs. Li/Li+), V₂O₅ (3.6 V vs. Li/Li+), and V₆O₁₃ (3.0 V vs. Li/Li+) and combinations thereof.

A positive electrode can be formed by mixing and forming a composition comprising, by weight, 0.01-15%, preferably 4-8%, of a polymer binder, 10-50%, preferably 15-25%, of the electrolyte solution of the invention herein described, 40-85%, preferably 65-75%, of an electrode-active material, and 1-12%, preferably 4-8%, of a conductive additive. Optionally, up to 12% of inert filler may also be added, as may such other adjuvants as may be desired by one of skill in the art, which do not substantively affect the achievement of the desirable results of the present invention. In one embodiment, no inert filler is used.

In one embodiment, the present invention provides a negative electrode, which includes electrode active materials and a current collector. The negative electrode comprises either a metal selected from the group consisting of Li, Si, Sn, Sb, Al and a combination thereof, or a mixture of one or more negative electrode active materials in particulate form, a binder, preferably a polymeric binder, optionally an electron conductive additive, and at least one organic carbonate. Examples of useful negative electrode active materials include, but are not limited to, lithium metal, carbon (graphites, coke-type, mesocarbons, polyacenes, carbon nanotubes, carbon fibers, and the like). Negative electrode-active materials also include lithium-intercalated carbon, lithium metal nitrides such as Li_{2.6}Co_{0.4}N, metallic lithium alloys such as LiAl or Li₄Sn, lithium-alloy-forming compounds of tin, silicon, antimony, or aluminum such as those disclosed in “Active/Inactive Nanocomposites as Anodes for Li-Ion Batteries,” by Mao et al. in Electrochemical and Solid State Letters, 2 (1), p. 3, 1999. Further included as negative electrode-active materials are metal oxides such as titanium oxides, iron oxides, or tin oxides.

When present in particulate form, the particle size of the negative electrode active material should range from about 0.01 to 100 microns, preferably from 1 to 100 microns. Some preferred negative electrode active materials include graphites such as carbon microbeads, natural graphites, carbon nanotubes, carbon fibers, or graphitic flake-type materials. Some other preferred negative electrode active materials are graphite microbeads and hard carbon, which are commercially available.

A negative electrode can be formed by mixing and forming a composition comprising, by weight, 2-20%, preferably 3-10%, of a polymer binder, 10-50%, preferably 14-28%, of the electrolyte solution of the invention herein described, 40-80%, preferably 60-70%, of electrode-active material, and 0-5%, preferably 1-4%, of a conductive additive. Optionally up to 12% of an inert filler as hereinabove described may also be added, as may such other adjuvants as may be desired by one of skill in the art, which do not substantively affect the achievement of the desirable results of the present invention. It is preferred that no inert filler be used.

Suitable conductive additives for the positive and negative electrode composition include carbons such as coke, carbon black, carbon nanotubes, carbon fibers, and natural graphite, metallic flake or particles of copper, stainless steel, nickel or other relatively inert metals, conductive metal oxides such as titanium oxides or ruthenium oxides, or electronically-conductive polymers such as polyacetylene, polyphenylene and polyphenylenevinylene, polyaniline or polypyrrole. Preferred additives include carbon fibers, carbon nanotubes and carbon blacks with relatively surface area below ca. 100 m²/g such as Super P and Super S carbon blacks available from MMM Carbon in Belgium.

The current collector suitable for the positive and negative electrodes includes a metal foil and a carbon sheet selected from a graphite sheet, carbon fiber sheet, carbon foam and carbon nanotubes sheet or film. High conductivity is generally achieved in pure graphite and carbon nanotubes film so it is preferred that the graphite and nanotube sheeting contain as few binders, additives and impurities as possible in order to realize the benefits of the present invention. Carbon nanotubes can be present from 0.01% to about 99%. Carbon fiber can be in microns or submicrons. Carbon black or carbon nanotubes may be added to enhance the conductivities of the certain carbon fibers. In one embodiment, the negative electrode current collector is a metal foil, such as copper foil. The metal foil can have a thickness from about 5 to about 300 micrometers.

The carbon sheet current collector suitable for the present invention may be in the form of a powder coating on a substrate such as a metal substrate, a free-standing sheet, or a laminate. That is the current collector may be a composite structure having other members such as metal foils, adhesive layers and such other materials as may be considered desirable for a given application. However, in any event, according to the present invention, it is the carbon sheet layer, or carbon sheet layer in combination with an adhesion promoter, which is directly interfaced with the electrolyte of the present invention and is in electronically conductive contact with the electrode surface.

The flexible carbon sheeting preferred for the practice of the present invention is characterized by a thickness of at most 2000 micrometers, with less than 1000 micrometers preferred, less than 300 micrometers more preferred, less than 75 micrometers even more preferred, and less than 25 micrometers most preferred. The flexible carbon sheeting preferred for the practice of the invention is further characterized by an electrical conductivity along the length and width of the sheeting of at least 1000 Siemens/cm (S/cm), preferably at least 2000 S/cm, most preferably at least 3000 S/cm measured according to ASTM standard C611-98.

The flexible carbon sheeting preferred for the practice of the present invention may be compounded with other ingredients as may be required for a particular application, but carbon sheet having a purity of ca. 95% or greater is highly preferred. At a thickness below about 10 lam, it may be expected that electrical resistance could be unduly high, so that thickness of less than about 10 μm is less preferred.

In some embodiments, the carbon current collector is a flexible free-standing graphite sheet. The flexible free-standing graphite sheet cathode current collector is made from expanded graphite particles without the use of any binding material. The flexible graphite sheet can be made from natural graphite, Kish flake graphite, or synthetic graphite that has been voluminously expanded so as to have d₀₀₂ dimension at least 80 times and preferably 200 times the original d₀₀₂ dimension. Expanded graphite particles have excellent mechanical interlocking or cohesion properties that can be compressed to form an integrated flexible sheet without any binder. Natural graphites are generally found or obtained in the form of small soft flakes or powder. Kish graphite is the excess carbon which crystallizes out in the course of smelting iron. In one embodiment, the current collector is a flexible free-standing expanded graphite. In another embodiment, the current collector is a flexible free-standing expanded natural graphite.

A binder is optional, however, it is preferred in the art to employ a binder, particularly a polymeric binder, and it is preferred in the practice of the present invention as well. One of skill in the art will appreciate that many of the polymeric materials recited below as suitable for use as binders will also be useful for forming ion-permeable separator membranes suitable for use in the lithium or lithium-ion battery of the invention.

Suitable binders include, but are not limited to, polymeric binders, particularly gelled polymer electrolytes comprising polyacrylonitrile, poly(methylmethacrylate), poly(vinyl chloride), and polyvinylidene fluoride and copolymers thereof. Also, included are solid polymer electrolytes such as polyether-salt based electrolytes including poly(ethylene oxide)(PEO) and its derivatives, poly(propylene oxide) (PPO) and its derivatives, and poly(organophosphazenes) with ethyleneoxy or other side groups. Other suitable binders include fluorinated ionomers comprising partially or fully fluorinated polymer backbones, and having pendant groups comprising fluorinated sulfonate, imide, or methide lithium salts. Preferred binders include polyvinylidene fluoride and copolymers thereof with hexafluoropropylene, tetrafluoroethylene, fluorovinyl ethers, such as perfluoromethyl, perfluoroethyl, or perfluoropropyl vinyl ethers; and ionomers comprising monomer units of polyvinylidene fluoride and monomer units comprising pendant groups comprising fluorinated carboxylate, sulfonate, imide, or methide lithium salts.

Gelled polymer electrolytes are formed by combining the polymeric binder with a compatible suitable aprotic polar solvent and, where applicable, the electrolyte salt. PEO and PPO-based polymeric binders can be used without solvents. Without solvents, they become solid polymer electrolytes, which may offer advantages in safety and cycle life under some circumstances. Other suitable binders include so-called “salt-in-polymer” compositions comprising polymers having greater than 50% by weight of one or more salts. See, for example, M. Forsyth et al, Solid State Ionics, 113, pp 161-163 (1998).

Also included as binders are glassy solid polymer electrolytes, which are similar to the “salt-in-polymer” compositions except that the polymer is present in use at a temperature below its glass transition temperature and the salt concentrations are ca. 30% by weight. In one embodiment, the volume fraction of the preferred binder in the finished electrode is between 4 and 40%.

The electrochemical cell optionally contains an ion conductive layer or a separator. The ion conductive layer suitable for the lithium or lithium-ion battery of the present invention is any ion-permeable shaped article, preferably in the form of a thin film, membrane or sheet. Such ion conductive layer may be an ion conductive membrane or a microporous film such as a microporous polypropylene, polyethylene, polytetrafluoroethylene and layered structures thereof. Suitable ion conductive layer also include swellable polymers such as polyvinylidene fluoride and copolymers thereof. Other suitable ion conductive layer include those known in the art of gelled polymer electrolytes such as poly(methyl methacrylate) and poly(vinyl chloride). Also suitable are polyethers such as poly(ethylene oxide) and poly(propylene oxide). Preferable are microporous polyolefin separators, separators comprising copolymers of vinylidene fluoride with hexafluoropropylene, perfluoromethyl vinyl ether, perfluoroethyl vinyl ether, or perfluoropropyl vinyl ether, including combinations thereof, or fluorinated ionomers, such as those described in Doyle et al., U.S. Pat. No. 6,025,092.

In another aspect, the present invention provides a battery pack. The battery pack includes a plurality of lithium-ion electrochemical cells. Each cell comprises an ionic liquid of formula (I):

Q⁺ E⁻ (I)

wherein Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls and R^{f} is alkyl or alkoxyalkyl; E⁻ is an anion selected from the group consisting of R¹—X⁻R²(R³)ₘ, NC—S⁻, BF₄⁻, PF₆⁻, R^{a}SO₃⁻, R^{a}P⁻F³, RaCO₂⁻, I⁻, ClO₄⁻, (FSO₂)₂N—, AsF₆⁻, SO₄⁻ and bis[oxalate(2-)-O,O′ borate, wherein m is 0 or 1. X is N when m is 0. X is C when m is 1. R¹, R² and R³ are each independently an electron-withdrawing group selected from the group consisting of halogen, —CN, —SO₂R^{b}, —SO₂-L^{a}-SO₂N⁻Li⁺SO₂R^{b}, —P(O)(OR^{b})₂, —P(O)(R^{b})₂, —CO₂R^{b}, —C(O)R^{b} and —H, with the proviso that R¹ and R² are other than hydrogen when m=0, and no more than one of R¹, R² and R³ is hydrogen when m=1. Each R^{a} is independently C₁₋₈perfluoroalkyl. Each R^{b} is independently selected from the group consisting of C₁₋₈alkyl, C₁₋₈haloalkyl, C₁₋₈ perfluoroalkyl, perfluorophenyl, aryl, optionally substituted barbituric acid and optionally substituted thiobarbituric acid, and wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and La is C₁₋₄perfluoroalkyl.

In some embodiments, the present invention provides a method of connecting a tab to an electrode in an electrochemical cell. The method includes (a) providing an electrode comprising an electrode active material and a carbon current collector in electronically conductive contact with the electrode; (b) providing a tab having a first attachment end for attaching to the electrode; and (c) connecting the first attachment end of the tab to the carbon current collector through a process selected from the group consisting of riveting, conductive adhesive lamination, staking, hot press, ultrasonic press, mechanical press, crimping, pinching, and a combination thereof. In one embodiment, the electrochemical cell is a lithium-ion electrochemical cell.

In one embodiment, the method includes aligning the carbon current collector with the tab and applying riveting, staking, conductive adhesive lamination, hot press, ultrasonic press, mechanical press, crimping, pinching, and a combination thereof to the carbon current collector. The tab can have various shapes, such as a U-shape, a V-shape, a L-shape, a rectangular-shape or a inverted T-shape. In one instance, the carbon current collector and the tab can be aligned to any desirable position for attachment. The carbon current collector can be aligned to any suitable part of the tab. For example, the carbon current collector is aligned to the middle, the side or a predetermined position of the tab. The tab and the current collector are joined together through riveting or staking

In another embodiment, the tab is connected to the carbon current collector through a conductive adhesive layer. In certain instances, the conductive layer is deposited on the tab. In one instance, the conductive layer is an adhesive layer comprising a conductive filler and a binder. The conductive filler is selected from the group consisting of carbon black, conducting polymers, carbon nanotubes and carbon composite materials. The conductive layer can have a thickness from about 1 nm to about 1000 micrometers. For example, the conductive layer has a thickness of about 1, 10, 20, 30, 40, 50, 60, 70, 80, 90 100, 200, 300, 400, 500, 600, 700, 800, 900 or 1000 nm. The conductive layer can also have a thickness of about 1, 10, 20, 30, 40, 50, 60, 70, 80, 90 100, 200, 300, 400, 500, 600, 700, 800, 900 or 1000 μm.

In another aspect, the present invention provides a battery. The battery includes a housing, a positive connector, a negative connector, a electrochemical cell disposed in the housing, where the positive and the negative connector are mounted on the housing. In one embodiment, the housing is a sealed container. In yet another embodiment, the tab is connected to the carbon current collector through a conductive adhesive layer then riveted, hot pressed, ultrasonic pressed, mechanical pressed, staked, crimped, or pinched.

In one embodiment, both the positive connector and the negative connectors have an inner end disposed within the housing and an outer end protrudes outside the housing. The positive electrode tab is welded to the inner end of the positive connector and the negative electrode tab is welded to the inner end of the negative connector to provide a battery having a positive outer end and a negative outer end for connecting to external devices. For example, the battery can have multiple tabs welded to the positive connector or the negative connector. The battery can be prepared by first attaching the tabs to the electrodes of the lithium-ion electrochemical cell. The electrodes and separator layers are then jelly-wound or stacked and placed in a battery container. The tabs for the positive electrode are welded to the inner end of the positive connector of the housing, and the tabs for the negative electrode are welded to the inner end of the negative connector of the housing. The housing is sealed and no tabs are exposed. In one embodiment, the housing is a container.

In another embodiment, the second attachment ends of the tabs of the battery are protruded outside the housing for connecting to an external device. For example, the battery can be prepared by first attaching the tabs to the electrodes of a lithium-ion electrochemical cell. The electrodes and separator are then jelly-wound or stacked and placed in a housing then sealed with only the tabs are protruded outside the housing. In one embodiment, the housing is a container.

In another embodiment, the carbon current collector for the positive electrode and/or the carbon current collector for the negative electrode protrude outside the housing. In one instance, the housing is a foil-polymer laminate package. The pores in the carbon current collector are closed or sealed by a resin or other material to provide as close to a hermetic seal as possible when the carbon current collector(s) are heat-sealed between two layers of the foil-laminate. The resins can be conductive or non-conductive resins.

The benefit of this design is that the metal tabs can be attached to the carbon current collectors outside of the cell and are not in contact with the corrosive electrolyte solution. This allows the use of a plurality of metals, metal alloys or composites.

The Li-ion electrochemical cell can be assembled according to any method known in the art (see, U.S. Pat. Nos. 5,246,796; 5,837,015; 5,688,293; 5,456,000; 5,540,741; and 6,287,722 as incorporated herein by reference). In a first method, electrodes are solvent-cast onto current collectors, the collector/electrode tapes are spirally wound along with microporous polyolefin separator films to make a cylindrical roll, the winding placed into a metallic cell case, and the nonaqueous electrolyte solution impregnated into the wound cell. In a second method electrodes are solvent-cast onto current collectors and dried, the electrolyte and a polymeric gelling agent are coated onto the separators and/or the electrodes, the separators are laminated to, or brought in contact with, the collector/electrode tapes to make a cell subassembly, the cell subassemblies are then cut and stacked, or folded, or wound, then placed into a foil-laminate package, and finally heat treated to gel the electrolyte. In a third method, electrodes and separators are solvent cast with also the addition of a plasticizer; the electrodes, mesh current collectors, electrodes and separators are laminated together to make a cell subassembly, the plasticizer is extracted using a volatile solvent, the subassembly is dried, then by contacting the subassembly with electrolyte the void space left by extraction of the plasticizer is filled with electrolyte to yield an activated cell, the subassembly(s) are optionally stacked, folded, or wound, and finally the cell is packaged in a foil laminate package. In a fourth method, the electrode and separator materials are dried first, then combined with the salt and electrolyte solvent to make active compositions; by melt processing the electrodes and separator compositions are formed into films, the films are laminated to produce a cell subassembly, the subassembly(s) are stacked, folded, or wound and then packaged in a foil-laminate container.

In one embodiment, the electrodes can conveniently be made by dissolution of all polymeric components into a common solvent and mixing together with the carbon black particles and electrode active particles. For example, a lithium battery electrode can be fabricated by dissolving polyvinylidene (PVDF) in 1-methyl-2-pyrrolidinone or poly(PVDF-co-hexafluoropropylene (HFP)) copolymer in acetone solvent, followed by addition of particles of electrode active material and carbon black or carbon nanotubes, followed by deposition of a film on a substrate and drying. The resultant electrode will comprise electrode active material, conductive carbon black or carbon nanotubes, and polymer. This electrode can then be cast from solution onto a suitable support such as a glass plate or a current collector, and formed into a film using techniques well known in the art.

The positive electrode is brought into electronically conductive contact with the graphite current collector with as little contact resistance as possible. This may be advantageously accomplished by depositing upon the graphite sheet a thin layer of an adhesion promoter such as a mixture of an acrylic acid-ethylene copolymer and carbon black. Suitable contact may be achieved by the application of heat and/or pressure to provide intimate contact between the current collector and the electrode.

The flexible carbon sheeting, such as carbon nanotubes or graphite sheet for the practice of the present invention provides particular advantages in achieving low contact resistance. By virtue of its high ductility, conformability, and toughness it can be made to form particularly intimate and therefore low resistance contacts with electrode structures that may intentionally or unintentionally proffer an uneven contact surface. In any event, in the practice of the present invention, the contact resistance between the positive electrode and the graphite current collector of the present invention preferably does not exceed 50 ohm-cm², in one instance, does not exceed 10 ohms-cm², and in another instance, does not exceed 2 ohms-cm². Contact resistance can be determined by any convenient method as known to one of ordinary skill in the art. Simple measurement with an ohm-meter is possible.

The negative electrode is brought into electronically conductive contact with an negative electrode current collector. The negative electrode current collector can be a metal foil, a mesh or a carbon sheet. In one embodiment, the current collector is a copper foil or mesh. In a preferred embodiment, the negative electrode current collector is a carbon sheet selected from a graphite sheet, carbon fiber sheet or a carbon nanotube sheet. As in the case of the positive electrode, an adhesion promoter can optionally be used to attach the negative electrode to the current collector.

In one embodiment, the electrode films thus produced are then combined by lamination with the current collectors and separator. In order to ensure that the components so laminated or otherwise combined are in excellent ionically conductive contact with one another, the components are combined with an electrolyte solution comprising an ionic liquid of formula (I) and a lithium imide or methide salt represented by the formula (II). In one embodiment, the electrolyte solution comprises a pure ionic liquid of formula (I). In another embodiment, the electrolyte solution comprises an ionic liquid of formula (I) and an organic carbonate or lactone as hereinabove described.

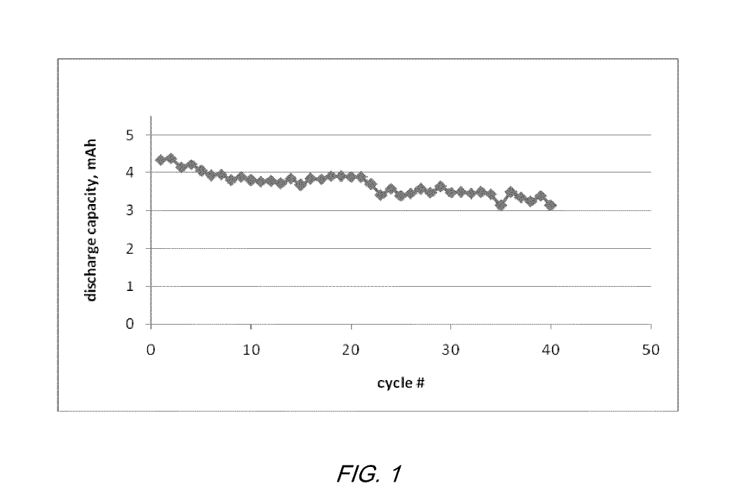

FIG. 1 shows a full cell having an electrolyte solution containing 1M LiTFSi dissolved in ethylene carbonate (EC)/1-butyl-1-methylpyrrolidinium bis(trifluoromethylsulfonyl)imide. Other ionic liquids of formula (I) can also be used. When a mixed solvents are used, the weight ratio of carbonate/ionic liquid or lactone/ionic liquid can be in the range between about 0.1% to about 99.9%. In one embodiment, the weight ratio of EC and ionic liquid of formula (I) is 1:1. The discharge capacity studies show that the full cell with ionic liquid electrolyte is stable even after 40 cycles.

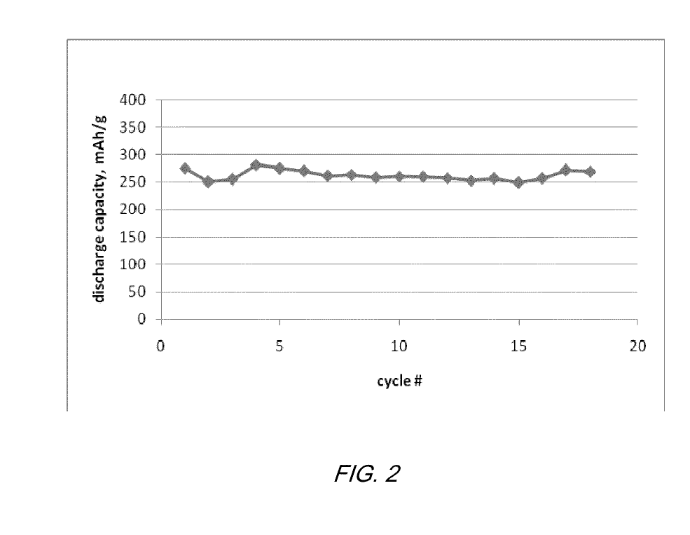

FIG. 2 illustrates an anode half cell having an electrolyte solution containing 1M Lilm dissolved in ethylene carbonate (EC)/1-butyl-1-methylpyrrolidinium bis(trifluoromethylsulfonyl)imide. Other ionic liquids of formula (I) can also be used. The weight ratio of carbonate/ionic liquid or lactone/ionic liquid can be in the range between about 0.1% to about 99.9%. In one embodiment, the weight ratio of EC and ionic liquid of formula (I) is 1:1. The discharge capacity studies show that the anode half-cell with ionic liquid electrolyte is stable even after 17 cycles. The cell capacity remains between about 250-300 mAh/g.

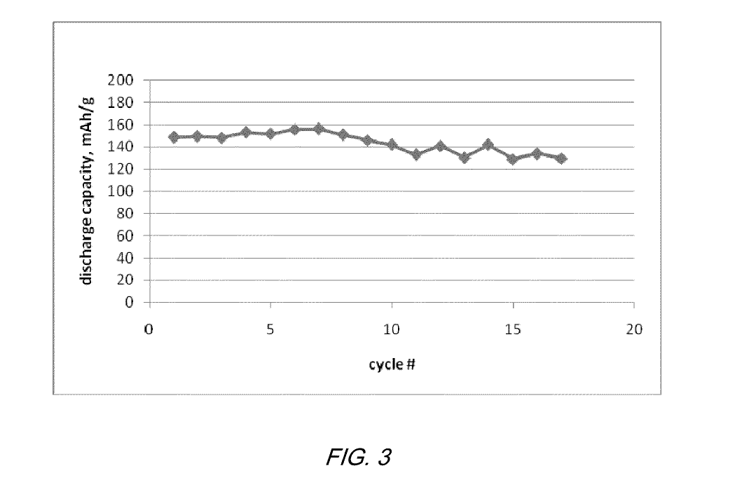

FIG. 3 illustrates a cathode half cell having an electrolyte solution containing 1M Lithium imide dissolved in ethylene carbonate (EC)/1-butyl-1-methylpyrrolidinium bis(trifluoromethylsulfonyl)imide in a 1:1 weight ratio. Other ionic liquids of formula (I) can also be used. The weight ratio of carbonate/ionic liquid or lactone/ionic liquid can be in the range between about 0.1% to about 99.9%. In one embodiment, the weight ratio of EC and ionic liquid of formula (I) is 1:1. The discharge capacity studies show that the cathode half-cell with ionic liquid electrolyte is stable even after 17 cycles. The cell capacity remains between about 120-140 mAh/g after 18 cycles. The columbic efficiency is 79% after the first cycle, which is close to that of conventional electrolyte.

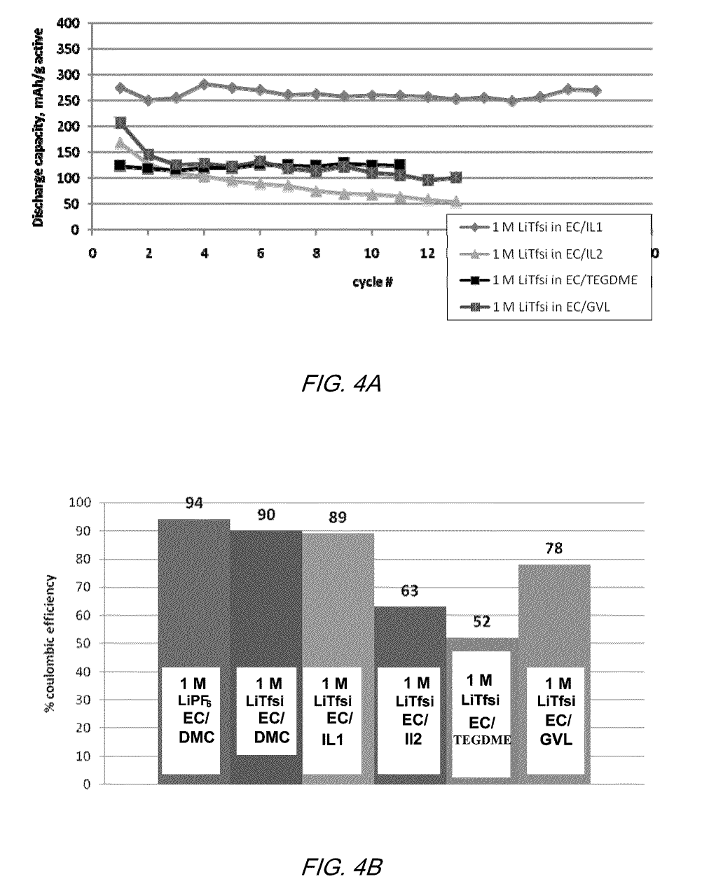

FIG. 4A shows a comparison of discharge capacity of cells having LiTFSI electrolyte solution with different ionic liquids. As shown in FIG. 4A, ethylene carbonate/1-butyl-1 methylpyrrolidinium bis(trifluoromethylsulfonyl)imide (IL1) cycles the best. FIG. 4B shows the first cycle columbic efficiencies. As shown in FIG. 4B, first cycle efficiency of ionic liquid containing electrolyte is comparable to LiTFSi electrolyte with conventional solvents EC/dimethyl carbonate (DMC).

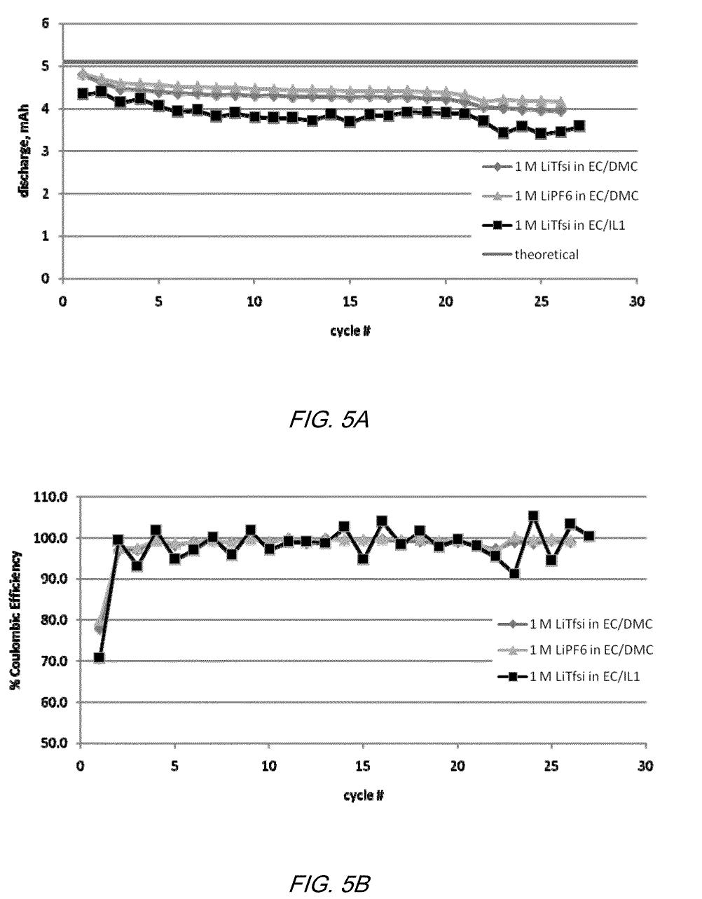

FIG. 5A shows the ionic liquid full cells having a graphite anode and a LiNi_{1/3}Mn_{1/3}Co_{1/3}O₂ cathode. The discharge capacity of the ionic liquid full cells was investigated and compared with that of a theoretical cell. The full cells containing ionic liquid electrolytes have stable cycling and the performance of the cells is comparable to that of cells with conventional electrolytes. FIG. 5B shows a comparison of the columbic efficiencies of three ionic liquid cells.

### EXAMPLE 1

### Production of a Negative Electrode

Ninety-two parts by weight of carbon mesosphere as the anode electrode active material, 1 part Super P Li as the conductive material, 107 parts by weight of a solution of 7 parts Kynar 301F, 0.4 parts oxalic acid and 99.6 parts N-methyl-2-pyrrolidinone were stirred and mixed together giving an anode electrode composition. This anode electrode composition was applied onto copper foil using a vacuum table and a doctor blade, then initially dried on a hotplate and followed by drying in an oven at 110° C. under vacuum for 2 hours and roll-pressed to an electrode with a thickness of about 1 micron to about 100 microns, thereby forming a negative electrode. Preferably, the thickness is about 49 microns.

### EXAMPLE 2

### Production of a Positive Electrode

Ninety-two parts by weight of lithium nickel manganese cobalt oxide as the cathode electrode active material, 4 part Super P Li as the conductive material, 104 parts by weight of a solution of 7 parts Kynar 301F and 100 parts N-methyl-2-pyrrolidinone were stirred and mixed together giving a cathode electrode composition. This cathode electrode composition was applied onto 50 micron graphite sheet using a vacuum table and a doctor blade, then initially dried on a hotplate and followed by drying in an oven at 110° C. under vacuum for 2 hours and roll-pressed to an electrode with thickness of about 1 micron to about 100 microns microns, thereby forming a positive electrode. Preferably, the thickness is about 41 microns

### EXAMPLE 3

### Preparation of Electrolyte Solution

An electrolyte solution was prepared by dissolving 28.69 g of lithium bis(trifluoromethane)imide in a solution of 50 parts by weight of ethylene carbonate and 50 parts 1-butyl-1-methyl-pyrrolidinium bis(trifluoromethane)imide that is sufficient to prepare a total of 100 ml of electrolyte solution.

### EXAMPLE 4

### Fabrication of a Lithium-Ion Electrochemical Full Cell

The positive and negative electrodes obtained as described above were cut in circular shape with a diameter of 1.2 cm. Hoshen 2032 coin cells were used to test the electrodes as a cell. The coin cell bottom, a spacer disk, the positive electrode saturated with electrolyte solution, a porous Celgard separator saturated with electrolyte solution, the negative electrode saturated with electrolyte solution, a spacer disk, a wave spring and the coin cell top with gasket were assembled in the order listed and crimped with a manual crimper to give a lithium-ion electrochemical cell.

### EXAMPLE 5

### Charge/Discharge Test

The lithium-ion electrochemical cell produced as described in Example 4 was subjected to charge/discharge test with charging including constant current of C/5 to 4.2 V and then constant voltage at 4.2 V for 3 hrs or until current drops below C/100 and discharging including constant current of C/5 to 3.0 V. The first cycle discharge capacity was 4.3 mAh and the first cycle charge-discharge efficiency was 71%. The capacity versus cycle number is plotted in FIG. 1.

### EXAMPLE 6

### Fabrication of a Lithium-Ion Electrochemical Half Cell

The cell was fabricated as in Example 4 except a lithium metal disk was used in place of the positive electrode.

### EXAMPLE 7

### Charge/Discharge Test

The electrochemical cell of Example 6 was subjected to charge/discharge test with charging including constant current of C/5 to 0.02 V and then constant voltage at 0.02 V for 3 hrs or until current drops below C/100 and discharging including constant current of C/5 to 1.5 V. The first cycle discharge capacity was 275 mAh/g and the first cycle charge-discharge efficiency was 89%. The capacity versus cycle number is plotted in FIG. 2.

### EXAMPLE 8

### Fabrication of a Lithium-Ion Electrochemical Half Cell

The cell was fabricated as in Example 4 except a lithium metal disk was used in place of the negative electrode.

### EXAMPLE 9

### Charge/Discharge Test

The electrochemical cell produced in Example 8 was subjected to charge/discharge test with charging including constant current of C/5 to 4.3 V and then constant voltage at 4.3 V for 3 hrs or until current drops below C/100 and discharging including constant current of C/5 to 3.0 V. The first cycle discharge capacity was 149 mAh/g and the first cycle charge-discharge efficiency was 79%. The capacity versus cycle number is plotted in FIG. 3.

### EXAMPLE 10

### Production of a Negative Electrode

Ninety-two parts by weight of carbon mesosphere as the anode electrode active material, 1 part Super P Li as the conductive material, 107 parts by weight of a solution of 7 parts Kynar 301F, 0.4 parts oxalic acid and 99.6 parts N-methyl-2-pyrrolidinone were stirred and mixed together giving an anode electrode composition. This anode electrode composition was applied onto copper foil using a vacuum table and a doctor blade, then initially dried on a hotplate and followed by drying in an oven at 110° C. under vacuum for 2 hours and roll-pressed to an electrode with a thickness of about 1 micron to about 100 microns, thereby forming a negative electrode. Preferably, the thickness is about 49 microns.

### Production of a Positive Electrode

Ninety-two parts by weight of lithium nickel manganese oxide (LiNi_{0.5}Mn_{1.5}O₄) as the cathode electrode active material, 4 part Super P Li as the conductive material, 104 parts by weight of a solution of 7 parts Kynar 301F and 100 parts N-methyl-2-pyrrolidinone is stirred and mixed together giving a cathode electrode composition. This cathode electrode composition is applied onto 50 micron graphite sheet using a vacuum table and a doctor blade, then initially dried on a hotplate and followed by drying in an oven at 110° C. under vacuum for 2 hours and roll-pressed to an electrode with thickness of about 1 micron to about 100 microns microns, thereby forming a positive electrode. Preferably, the thickness is about 41 micron.

### Preparation of Electrolyte Solution

An electrolyte solution is prepared by dissolving 28.69 g of lithium bis(trifluoromethane)imide in a solution of 50 parts by weight of ethylene carbonate and 50 parts 1-butyl-1-methyl-pyrrolidinium bis(trifluoromethane)imide that is sufficient to prepare a total of 100 ml of electrolyte solution.

### Fabrication of a Lithium-Ion Electrochemical Full Cell

The positive and negative electrodes obtained as described above are cut in circular shape with a diameter of 1.2 cm. Hoshen 2032 coin cells are used to test the electrodes as a cell. The coin cell bottom, a spacer disk, the positive electrode saturated with electrolyte solution, a porous Celgard separator saturated with electrolyte solution, the negative electrode saturated with electrolyte solution, a spacer disk, a wave spring and the coin cell top with gasket is assembled in the order listed and crimped with a manual crimper to give a lithium-ion electrochemical cell.

### Charge/Discharge Test

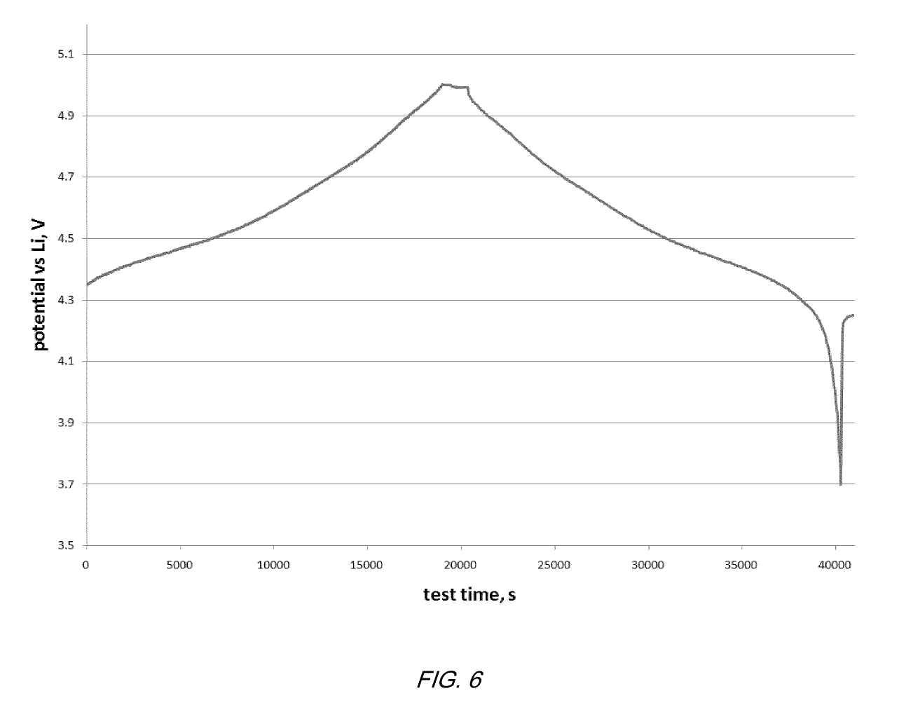

The lithium-ion electrochemical cell produced as described in Example 4 are subjected to charge/discharge test with charging including constant current of C/5 to 5.0 V and then constant voltage at 5.0 V for 3 hrs or until current drops below C/100 and discharging including constant current of C/5 to 3.7 V. The voltage versus test time for the first cycle is plotted in FIG. 6.

While the invention has been described by way of example and in terms of the specific embodiments, it is to be understood that examples and embodiments described herein are for illustrative purposes only and the invention is not limited to the disclosed embodiments. It is intended to cover various modifications and similar arrangements as would be apparent to those skilled in the art. Therefore, the scope of the appended claims should be accorded the broadest interpretation so as to encompass all such modifications and similar arrangements. All publications, patents, and patent applications cited herein are hereby incorporated by reference in their entirety for all purposes.

1. A lithium-ion electrochemical cell comprising:
a positive electrode comprising a positive electrode active material and a free-standing carbon sheet current collector in electronically conductive contact with the positive electrode material, wherein the carbon sheet current collector has a purity of greater than 95% and an in-plane electronic conductivity of at least 1000 S/cm;
a negative electrode comprising a negative electrode active material and a current collector in electronically conductive contact with the negative electrode material;
an ion permeable separator; and
an electrolyte solution in ionically conductive contact with said negative electrode and positive electrode, wherein the electrolyte solution comprises a lithium compound and a solvent selected from an ionic liquid of formula (I) or a mixture of an organic solvent and an ionic liquid of formula (I):
Q⁺E⁻ (I)
wherein
Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5-or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls;
E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N−, AsF₆⁻, SO₄⁻ and bis[oxalate(2-)-O,O′]borate, wherein
m is 0 or 1;
X is N when m is 0;
X is C when m is 1;
R¹, R² and R³ are each independently an electron-withdrawing group selected from the group consisting of halogen, —CN, —SO₂R^{b}, —SO₂—L^{a}—SO₂N⁻Li⁺SO₂R^{b}, —P(O)(OR^{b})₂, —P(O)(R^{b})₂, —CO₂R^{b}, —C(O)R^{b} and —H; with the proviso that R¹ and R² are other than hydrogen when m=0, and no more than one of R¹, R² and R³ is hydrogen when m=1;
each R^{a} is independently C₁₋₈perfluoroalkyl;
each R^{b} is independently selected from the group consisting of C₁₋₈alkyl, C₁₋₈haloalkyl, C₁₋₈ perfluoroalkyl, perfluorophenyl, aryl, optionally substituted barbituric acid and optionally substituted thiobarbituric acid;
each R^{f} is independently alkyl or alkoxyalkyl; and
wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene.

2. The cell of claim 1, wherein the organic solvent is a carbonate, a lactone or a mixture thereof.

3. The cell of claim 1, wherein solvent is a mixture of an organic solvent and an ionic liquid and wherein the organic solvent and the ionic liquid has a volume ratio from about 1:10 to about 10:1 solvent is a mixture of an organic solvent and an ionic liquid.

4. The cell of claim 1, wherein the anion is CF₃SO₂X⁻R²(R³)ₘ.

5. The cell of claim 1, wherein the anion is selected from the group consisting of (CF₃SO₂)₃C⁻, (CF₃SO₂)₂CH⁻, CF₃(CH₂)₃SO₃⁻, (CH₃SO₂)₂N⁻, (CN)₂N⁻, SO₄⁻, CF₃SO₃⁻, NC—S⁻, BF₄⁻, PF₆⁻, ClO₄⁻, (CF₃CF₂)₃P⁻R₃, CH₃CO₂⁻, I⁻, SO₄⁻ and bis[oxalate(2-)-O,O′]borate.

6. The cell of claim 1, wherein the positive electrode active material comprises phosphates, sulfates or a lithium insertion transition metal oxide selected from the group consisting of LiCoO₂, spinel LiMn₂O₄, chromium-doped spinel lithium manganese oxide, layered LiMnO₂, LiNiO₂, LiNiₓCo₁₋ₓO₂, vanadium oxide, LiFePO₄, LiFeTi(SO₄)₃, Li₁₊ₓA_{y}M_{2-y}O₄ and LiMXO₄,
wherein:
the subscript x is a real number between about 0 and 1;
the subscript y is a real number between about 0 and 1;
M and A are each independently Fe, Mn, Co, Ni or a combination thereof; and
X is P, V, S, Si or a combination thereof.

7. The cell of claim 6, wherein the positive electrode active material comprises LiNi_{0.5}Mn_{1.5}O₄.

8. The cell of claim 1, wherein the negative electrode active material comprises lithium-intercalated carbon, lithium metal nitride, metallic lithium alloy, metal oxide, carbon microbeads, a natural graphite, a carbon fiber, a graphite microbead, a carbon nanotube, hard carbon or a graphite flake or a combination thereof.

9. The cell of any of claim 1, wherein the current collector is a conductive carbon sheet selected from the group consisting of a graphite sheet, a carbon fiber sheet, a carbon foam and a carbon nanotube film and/or a mixture thereof.

10. The cell of claim 9, wherein the in-plane electronic conductivity of the conductive carbon sheet is at least 2000 S/cm.

11. The cell of claim 9, wherein the in-plane electronic conductivity of the conductive carbon sheet is at least 3000 S/cm.

12. The cell of claim 1, wherein the lithium compound has formula: Li⁺E⁻.

13. The cell of claim 12, wherein the lithium compound is LiPF₆, LiBF₄, LiClO₄, (FSO₂)₂N⁻Li⁺ or AsF₆⁻.

14. The cell of claim 1, wherein the lithium compound has formula (II):
R¹—X⁻(Li⁺)R²(R³ )ₙ II
wherein:
n is 0 or 1;
X is N when n is 0;
X is C when n is 1;
R¹, R² and R³ are each independently an electron-withdrawing group selected from the group consisting of halogen, —CN, —SO₂R^{b}, —SO₂(—R^{b}—SO₂Li⁺)SO₂—R^{b}, —P(O)(OR^{b})₂, —P(O)(R^{b})₂, —CO₂R^{b}, —C(O)R^{b} and —H; with the proviso that R¹ and R² are other than hydrogen when n=0, and no more than one of R¹, R² and R³ is hydrogen when n=1; and
wherein each R^{b} is independently selected from the group consisting of C₁₋₈ alkyl, C₁₋₈haloalkyl, C₁₋₈ perfluoroalkyl, perfluorophenyl, aryl, optionally substituted barbituric acid and optionally substituted thiobarbituric acid, wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is C₁₋₈ alkyl, perfluorophenyl or C₁₋₈ perfluoroalkyl, wherein the compound has an oxidation potential above the recharged potential of the positive electrode.

15. The cell of claim 14, wherein the lithium compound having the formula: CF₃SO₂N⁻(Li⁺)SO₂CF₃.

16. The cell of claim 1, wherein Q⁺ is a cation having formula (Ia): 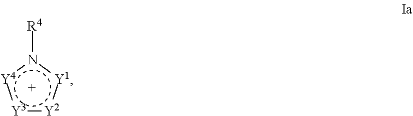
wherein
R⁴ is —H, C₁₋₂₀ alkyl or C₁₋₂₀alkoxyalkyl, optionally substituted with from 1-3 members selected from the group consisting of halogen and C₁₋₄perfluoroalkyl;
Y¹ and Y³ are each independently selected from the group consisting of ═N— and ═CR^{d}—;
Y² and Y⁴ are each independently selected from the group consisting of ═N—, —O—, —S—, —NR^{d}— and ═CR^{d}—, with the proviso that Y² and Y⁴ are not simultaneously a member selected from the group consisting of —NR^{d}— and ═CR^{d}—, or simultaneously a member selected from the group consisting of —O—, —NR^{d}— and —S—;
wherein each R^{d} is independently —H, alkyl or alkoxyalkyl.

17. The cell of claim 16, wherein Q⁺ is a cation having formula Ia-1:

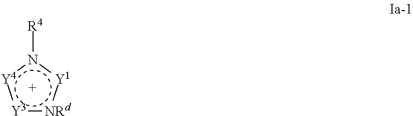

18. The cell of claim 17, wherein Y¹ is ═N— or ═CR^{d}—.

19. The cell of claim 18, wherein Y¹ is ═CR^{d}—.

20. The cell of claim 17, wherein Y⁴ is —O—.

21. (canceled)

22. The cell of claim 17, wherein Y¹, Y³ and Y⁴ are ═CH—, R⁴ is methyl and R^{d} is C₁₋₈alkyl or C₁₋₈alkoxyalkyl.

23. The cell of claim 1, wherein Q⁺ is a cation having formula (Ib): 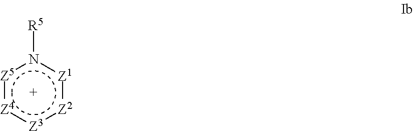
wherein
R⁵ is —H, alkoxyalkyl or C₁₋₂₀alkyl, optionally substituted with from 1-3 members selected from the group consisting of halogen and C₁₋₄perfluoroalkyl; and
Z¹, Z², Z³, Z⁴ and Z⁵ are each independently selected from the group consisting of ═N— and ═CR^{e}—, wherein each R^{e} is independently selected from the group consisting of —H, alkyl and alkoxyalkyl, or optionally the R^{e} substituents on the adjacent carbons are combined with the atoms to which they are attached form a 5- or 6-membered ring having from 0-2 addition heteroatoms as ring members selected from O, N or S.

24. The cell of claim 23, wherein Z¹ is ═N—.

25. The cell of claim 24, wherein Z², Z³, Z⁴ and Z⁵ are ═CR^{e}—.

26. The cell of claim 23, wherein Z² is ═N—.

27. The cell of claim 26, wherein Z¹, Z³, Z⁴ and Z⁵ are ═CR^{e}—.

28. The cell of claim 23, wherein Z³ is ═N—.

29. The cell of claim 28, wherein Z¹, Z², Z⁴ and Z⁵ are ═CR^{e}—.

30. (canceled)

31. The cell of claim 1, wherein Q⁺ is a cation having formula (Ic): 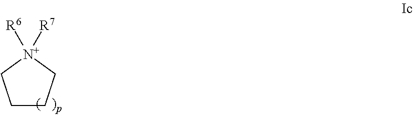
wherein
the subscript p is 1 or 2; and
R⁶ and R⁷ are each independently H or an optionally substituted C₁₋₈alkyl.

32. The cell of claim 31, wherein p is 1 and R⁶ and R⁷ are each independently an optionally substituted C₁₋₈alkyl.

33. The cell of claim 32, wherein R⁶ and R⁷ are each independently a C₁₋₈alkyl.

34. The cell of claim 33, wherein p is 1, R⁶ is methyl and R⁷ is C₁₋₈alkyl.

35. (canceled)

36. A battery pack comprising a plurality of cells, wherein each cell comprises:
an ionic liquid of formula (I):
Q⁺E^{-(I)}
wherein
Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls;
E⁻is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻ and bis[oxalate(2-)O,O′]borate, wherein
m is 0 or 1;
X is N when m is 0;
X is C when m is 1;
R¹, R² and R³ are each independently an electron-withdrawing group selected from the group consisting of halogen, —CN, —SO₂R^{b}, —SO₂-L^{a}-SO₂N⁻Li⁺SO₂R^{b}, —P(O)(OR^{b})₂, —P(O)(R^{b})₂, —CO₂R^{b}, —C(O)R^{b} and —H; with the proviso that R¹ and R² are other than hydrogen when m=0, and no more than one of R¹, R² and R³ is hydrogen when m=1;
each R^{a} is independently C₁₋₈perfluoroalkyl;
each R^{b} is independently selected from the group consisting of C₁₋₈alkyl, C₁₋₈haloalkyl, C₁₋₈ perfluoroalkyl, perfluorophenyl, aryl, optionally substituted barbituric acid and optionally substituted thiobarbituric acid;
each R^{f} is independently alkyl or alkoxyalkyl; and
wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene; and
a positive electrode comprising a positive electrode active material and a free-standing carbon sheet current collector in electronically conductive contact with the positive electrode material, wherein the carbon sheet current collector has a purity of greater than 95% and an in-plane electronic conductivity of at least 1000 S/cm.

37. A lithium-ion electrochemical cell comprising:
a positive electrode comprising a positive electrode active material and a free-standing carbon sheet current collector in electronically conductive contact with the positive electrode material, wherein the carbon sheet current collector has a purity of greater than 95% and an in-plane electronic conductivity of at least 1000 S/cm;
a negative electrode comprising a negative electrode active material and a current collector in electronically conductive contact with the negative electrode material;
at least one positive electrode tab having a first attachment end and a second attachment end, wherein the first attachment end of said at least one positive electrode tab is connected to said positive electrode carbon sheet current collector;
at least one negative electrode tab having a first attachment end and a second attachment end, wherein said first attachment end of said at least one negative electrode tab is connected to said negative electrode current collector;
an ion permeable separator; and
an electrolyte solution in ionically conductive contact with said negative electrode and positive electrode, wherein the electrolyte solution comprises a lithium compound and a solvent selected from an ionic liquid of formula (I) or a mixture of an organic solvent and an ionic liquid of formula (I):
Q⁺E⁻ (I)
wherein
Q⁺ is a cation selected from the group consisting of dialkylammonium, trialkylammonium, tetraalkylammonium, dialkylphosphonium, trialkylphosphonium, tetraalkylphosphonium, trialkylsulfonium, (R^{f})₄N⁺ and an N-alkyl or N-hydrogen cation of a 5- or 6-membered heterocycloalkyl or heteroaryl ring having from 1-3 heteroatoms as ring members selected from N, O or S, wherein the heterocycloalkyl or heteroaryl ring is optionally substituted with from 1-5 optionally substituted alkyls;
E⁻ is an anion selected from the group consisting of R¹—X⁻R²(R³)ₘ, NC—S⁻, BF₄⁻, PF₆⁻, R^{a}SO₃⁻, R^{a}P⁻F₃, R^{a}CO₂⁻, I⁻, ClO₄⁻, (FSO₂)₂N—, AsF₆⁻, SO₄⁻ and bis[oxalate(2-)-O,O′]borate, wherein
m is 0 or 1;
X is N when m is 0;
X is C when m is 1;
R¹, R² and R³ are each independently an electron-withdrawing group selected from the group consisting of halogen, —CN, —SO₂R^{b}, —SO₂-L^{a}-SO₂N⁻Li⁺SO₂R^{b}, —P(O)(OR^{b})₂, —P(O)(R^{b})₂, —CO₂R^{b}, —C(O)R^{b} and —H; with the proviso that R¹ and R² are other than hydrogen when m=0, and no more than one of R¹, R² and R³ is hydrogen when m=1;
each R^{a} is independently C₁₋₈perfluoroalkyl;
each R^{b} is independently selected from the group consisting of C₁₋₈alkyl, C₁₋₈haloalkyl, C₁₋₈ perfluoroalkyl, perfluorophenyl, aryl, optionally substituted barbituric acid and optionally substituted thiobarbituric acid;
each R^{f} is independently alkyl or alkoxyalkyl; and
wherein at least one carbon-carbon bond of the alkyl or perfluoroalkyl are optionally substituted with a member selected from —O— or —S— to form an ether or a thioether linkage and the aryl is optionally substituted with from 1-5 members selected from the group consisting of halogen, C₁₋₄haloalkyl, C₁₋₄perfluoroalkyl, —CN, —SO₂R^{c}, —P(O)(OR^{c})₂, —P(O)(OR^{c})₂, —P(O)(R^{c})₂, —CO₂R^{c} and —C(O)R^{c}, wherein R^{c} is independently C₁₋₈ alkyl, C₁₋₈ perfluoroalkyl or perfluorophenyl and L^{a} is C₁₋₄perfluoroalkylene.

38. The cell of claim 37, wherein the in-plane electronic conductivity of the conductive carbon sheet is at least 2000 S/cm.

39. The cell of claim 37, wherein the in-plane electronic conductivity of the conductive carbon sheet is at least 3000 S/cm.
